(19) United States
(12) Patent Application Publication
(10) Pub. No.: US 2005/0281961 A1
(43) Pub. Date: Dec. 22, 2005

(54) Polymer film, solution casting method and apparatus

(75) Inventor: Hiroshi Miyachi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/155,615

(22) Filed: Jun. 20, 2005

(30) Foreign Application Priority Data
Jun. 18, 2004 (JP) 2004-181366

(51) Int. Cl. C09K 19/00

(52) U.S. Cl. 428/1.31

(57) ABSTRACT

Air is flown above a casting film. Further, plural guide boards are provided between an aeration duct and an emission duct in order to control the direction of air flow. The air passes through the direction at which the casting film moves. If the thickness data of the obtained film are continuously measured along the direction (except 90°) intersecting a longitudinal direction, the thickness unevenness is at most ±2 μm when a thickness average is considered as a standard value zero and the value V is at most 300×10⁻⁵. V is calculated on the formula V=Σ{(dYn)/(dXn)}²/n, when the thicknesses at each point is defined as Yn, the each distance is defined as Xn between the said starting measuring point PS1 and each selected point. These points are selected on the line of the thickness data.

### BACKGROUND OF THE INVENTION

1. Field of the Invention

The present invention relates to a polymer film, a solution casting method of producing a film and an apparatus for producing a film, particularly a polymer film, a method and an apparatus for producing the polymer film, which is used in a polarizing filter and a liquid crystal display.

2. Description Related to the Prior Art

A liquid crystal display (LCD) comprises a polarizing filter and an optical compensation film. In many cases the polarizing filter has a protective film on each side of a polarized film. Recently an optical compensation film is substituted for one of the protective films on the polarized film in some cases. For example, an elliptical polarizing filter. At the result of this, a contrast in the LCD increases and the display device can be thinned.

Otherwise, the LCD become demanded and, especially for use of a display device in a LCD television. In the LCD television, a prior display device is needed to be made with the screen and brightness are bigger and higher, compared with that in a conventional measuring device and a computer.

By the way, some sort of optical films including an optical compensation film and a protective film and the like used in the LCD are produced by a solution casting method or a melt-extrusion method depending on kinds of material. Especially the cellulose acylate film produced by the solution casting method shows transparency, optical isotropy and moderate hydroscopic property, so it is used widely as the protective film featuring the optical compensation function.

And, many prior arts were proposed to improve unevenness of film thickness about a polymer film which is used for an optical compensation film in a TN mode type or a wideview film in another type of LCD and the like, and the film become to show the predetermined optical function. For example, Japanese Patent Examined Publication No. 5-17844 teaches the method in which concentration of solid components in a polymer solution to be cast, and the ratio of the ingredient of solvent and the temperature of the support are set to the predetermined value to reduce remainings from the peeling on a support. This is how the film shows flatness and smoothness.

A polymer film produced by a prior method typically listed in Japanese Patent Examined Publication No. 5-17844 satisfies capability for the prior LCD, however if the film is applied in the LCD with screen and brightness being bigger and higher than prior one as above mentioned, there is a problem that the displaying unevenness (the optical unevenness) appears in the LCD. And this displaying unevenness (the optical unevenness) appears with a linear form in both of the vertical and horizontal directions of the LCD in many cases.

The FIG. 8 is the explanatory view which shows the method of cutting a film produced by a solution casting method in case for the use of the LCD. In a solution casting method, a polymer solution is continuously cast onto a moving support to form a casting film to be peeled, and thus a long film is formed and next, dried. In order to make orientation of polymer molecules determined state in drying process, the film is ordinarily tensioned in width direction with both sides edge portions of the film held by a holding device. Taking this orientation of polymer molecules into consideration, the film is cut. In FIG. 8, X direction means the longitudinal direction, Y direction means the width direction and the dotted line does cutting lines. As shown in FIG. 8, plurality of polymer sheets are obtained by cutting at an angle of 45° from the longitudinal direction. Note that the angle of 45° from the longitudinal direction is synonymous with the angle of 45°from width direction. FIG. 8 also shows that five sheets from (a) to (e) are obtained along the direction at an angle of 45° from longitudinal direction.

Investigating an optical unevenness in these sheets, the optical unevenness is detected in all from (a) to (e), and there is a problem that the optical unevenness extremely appear in the direction from center to edges in the width direction. Note that in a method of investigating the optical unevenness, the sheet is sandwitched between two sheets of the polarizing filter with crossed nicols arrangement. The method is a well-known method.

Then, the inventors examined the above sheets, concretely the relation between the optical unevenness and the thickness in one sheet (c) circled with the long dashed double-dotted line in sheets as shown in FIG. 8 to examine the cause of the optical unevenness. And the optical unevenness is visible by marking in sheet (c). The state of the marks is shown in the magnified drawing in FIG. 8. This magnified drawing shows that there is the mark at the angle of 45° from both X and Y direction. And, when the thickness of the sheet is measured along the marks, it is observed that a thickness unevenness appears more notedly than in no marked part.

Preferably the thickness of the above film for optical use as described above is from 20 μm to 100 μm. The data is shown in FIG. 9 on the thickness of the film whose thickness average is 90 μm, which is measured along the direction at the angle of 45° as described above. Graph (a) shows the thickness data of the film 201 shown in FIG. 8, Graph (b) shows the thickness data of another film. With reference to the data on (a) and (b), the data spread of the thickness, or the difference of a maximum value and a minimum value, is about 1 μm in each of (a) and (b), and the ratio of spread of the thicknesses to the thickness average is about 12% in each of the datas. These values are very small. But if the film with the property is used for those devices with big screen and high brightness, the optical unevenness appears. It is proved that the only spread of the thickness within predetermined range doesn't make those devices in the predetermined displaying state.

### SUMMARY OF THE INVENTION

An object of the present invention is to provide a polymer film in which the optical unevenness doesn't appear even if used in the LCD with big screen and high brightness, the method and the apparatus for producing the film. In order to solve the problem as described above, a polymer film produced to be long by a solution casting method or a melt-extrusion method comprises a characteristic that difference both between average and a maximum and between average and a minimum in thickness of the polymer film measured in a direction (except 90°) intersecting the longitudinal direction are at most 2 μm. Alternativly or addingly, a polymer film produced to be long by a solution casting method or a melt-extrusion method comprises a characteristic which satisfies a following formula:
V<300×10⁻⁵

wherein
V=Σ{(dYₙ)/(dXₙ)}²/n,

(dYₙ)/(dXₙ): rate of change of Yₙ with respect to Xₙ,

n: number N of measuring values arbitrarily selected from a thickness data along a direction (except 90°) intersecting the longitudinal direction (n is natural number and at least 5.),

Xₙ (unit;mm): distance between a starting point PS1 of the measuring and each measuring point Pₙ corresponding to each of the selected measuring value,

Yₙ (unit; μm): thickness on each of the measuring point Pn.

The polymer film is used as a protective film in a polarizing filter which has the protective film on a polarized film, and that polarizing filter is in a liquid crystal display which has an illuminator having brightness at least 8000 candela and also at most 50000 candela.

An apparatus in the present invention comprises a casting device for casting a polymer solution from a casting die onto a moving support to form a casting film and peeling the casting film so as to form a film containing a solvent, a drying device for drying the film, an aerating unit provided near the support for applying air to the casting film, a recovering unit provided near the support for recovering the air containing solvent vaporized from the casting film at downstream side from the aerating unit, and plural guide members provided between the aerating unit and the recovering unit. Wherein the plural guide members make a flowing direction of the air to be along a direction in which the casting film moves.

Furthermore, a solution casting method of the present invention comprises steps of casting a polymer solution on a moving support to form a casting film, peeling the casting film so as to form a film containing a solvent, feeding air by an aerating unit to the casting film which is solidified into a certain hardness, making a flowing direction of the air to be along a direction in which the casting film moves, wherein a direction of the air is controlled by guide members and recovering the air containing the solvent vaporized from the casting film by a recovering unit.

In the above invention, preferably, a windless state is maintained around the casting film until the casting film becomes to be the predetermined hardness. More preferably the solvent vaporized from the casting film is condensed by a condenser so as to accelerate drying of the casting film, Alternativly or addingly an opposite surface of the support is heated with using a heater to a casting surface onto which the polymer solution is cast.

The present invention makes the generation of the optical unevenness reduced. And the generation of displaying unevenness can be reduced effectively by using the polymer film obtained by the present invention in a LCD with big screen and high brightness.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a plan view of a film in the present invention;

FIG. 2 is an explanatory view of a section of data of thickness of a film measured along the predetermined direction;

FIG. 3a is data of thickness of a film by the embodiment;

FIG. 3b is data of thickness of a film by another embodiment of this present invention;

FIG. 4 is a schematic diagram of a dope producing apparatus;

FIG. 5 is a schematic diagram of an apparatus for a solution casting method of producing a film;

FIG. 6 is a plan view of a potion of a casting film;

FIG. 7 is a sectional view along a line VII-VII in FIG. 6;

FIG. 8 is explanatory view of an optical unevenness generated in an ordinary film;

FIGS. 9(a)(b) are data of thickness of divergent ordinary films;

### PREFERRED EMBODIMENTS OF THE INVENTION

An embodiment of this present invention is described in detail. First, a film in the present invention is described, next a method of producing the film.

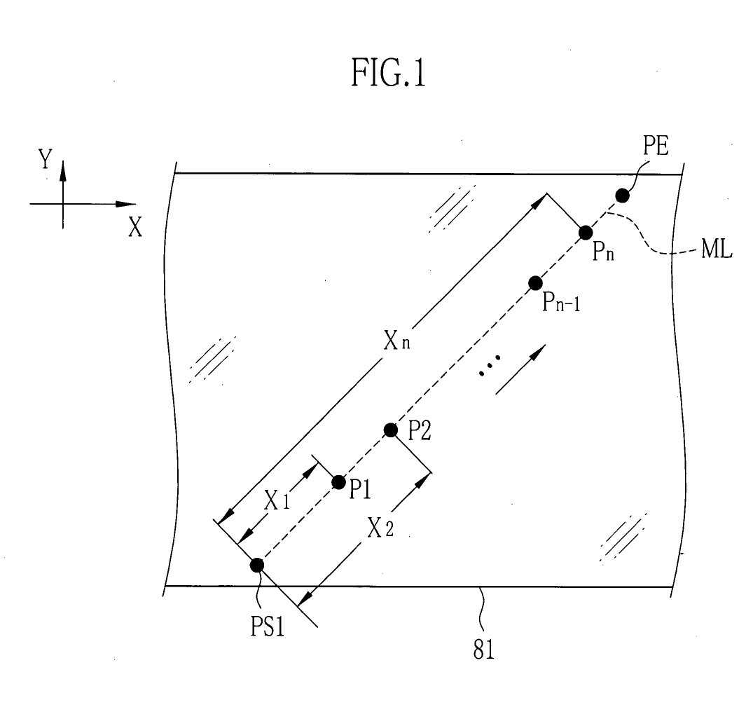

A film is continuously produced by a solution casting method in the present invention undermentionedly. X and Y direction in FIG. 1 intersect at the angle of 90°, and X direction is a longitudinal direction and Y direction is a width direction. Thickness of a film 81 is measured continuously along a direction intersecting X direction except Y direction. A dashed line ML shows the line along which measurement is made in FIG. 1. And preferably a measuring starting point (herein after, starting point) PS1 and a measuring end point (herein after, end point) PE for measurement are determined so that the area to be used by cutting in accordance to use may be contained. But not necessarily determined so, for example, in case that a film is cut and the sheets are used independently, the two points PS1, PE may be determined so that each sheet area between the two points PS1, PE contains one sheet.

As shown in FIG. 1, plural points are arbitrarily selected on the measurement line ML. When the number of selected data N is n (n is natural number and greater than 1), each selected point is named P1, P2, . . . , P(n-1), Pn from the starting point PS1 side. Each distance between the starting point PS1 and each selected point P1, P2, . . . , P(n-1), Pn is named X1, X2, to X(n-1), Xn. Note that, n is more preferably at least 5.

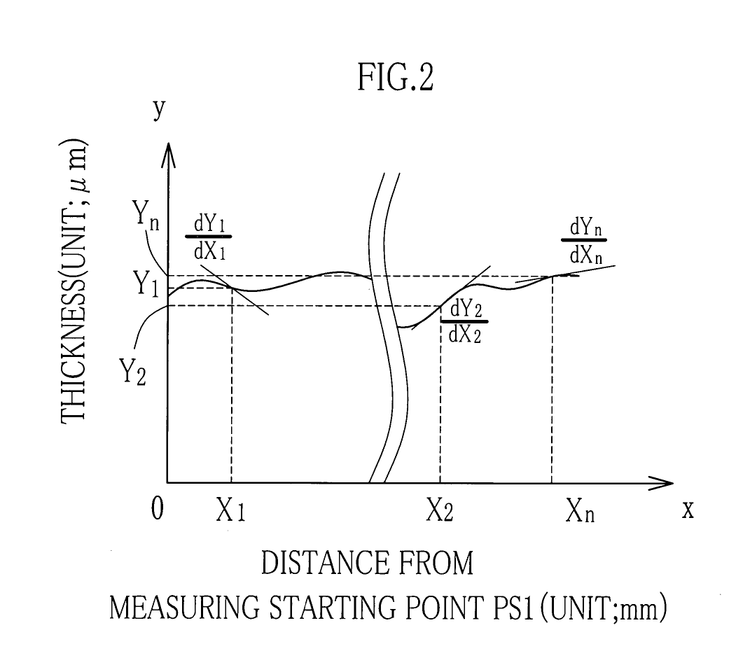

And, in the data of the thickness in FIG. 2, x-axis means the distance and y-axis does the thickness (unit μm). A rate of change of the thickness at each selected point P1, P2, . . . , P(n-1) and P(n), that is, in FIG. 2, the rate of change of thickness at each point corresponding to the each distance X1, X2, . . . , X(n-1), X(n) from the measuring starting point PS1 to each P1, P2, . . . , P(n-1) and P(n), are the gradient at predetermined points on graph in FIG. 2, and is a value obtained as dY₁/dX₁, dY₂/dX₂, . . . , dYₙ₋₁/dXₙ₋₁, dYₙ/dXₙ.

When a variance V is calculated by a formula V=Σ{(dYₙ)/(dXₙ)}²/n, V value about the film 81 (shown in FIG. 1) is less than 300×10⁻⁵. If the film 81 of which V value is at least 300×10⁻⁵ is used in a LCD comprising a illuminator which has at least predetermined brightness, the optical unevenness may appear in the vertical and horizontal direction on the screen of the LCD. The less the value V is, the more preferable, and the V value is more preferably less than 150×10⁻⁵. Note that, if the film 81 of the present invention is used as a protective film of a polarizing filter in LCD with illuminator with brightness in the range of 5000 candela to 50000 candela, especially the generation of the optical unevenness is reduced in the film and the film 81 performs well for displaying. And also, the film 81 is optimally used as an optical compensation film besides the protective film in the polarizing filter.

Note that, in the embodiment of the present invention, the measurement of the thickness was continuously made in an oblique direction by a measuring device commercially produced (type; electro micro meter, Anritsu. Co. Ltd.). But the measurement is not necessarily made in a continuous way if the rate of change of the thicknesses of the film at the above each point can be even measured. In this case, the value V is calculated on a result that the rates of change of thickness ((dYₙ)/(dXₙ)) are calculated when Yₙ is defined as the thickness at the each sampling point, and Xₙ is defined as the distance from the one end of the predetermined measurement line ML to the each sampling point.

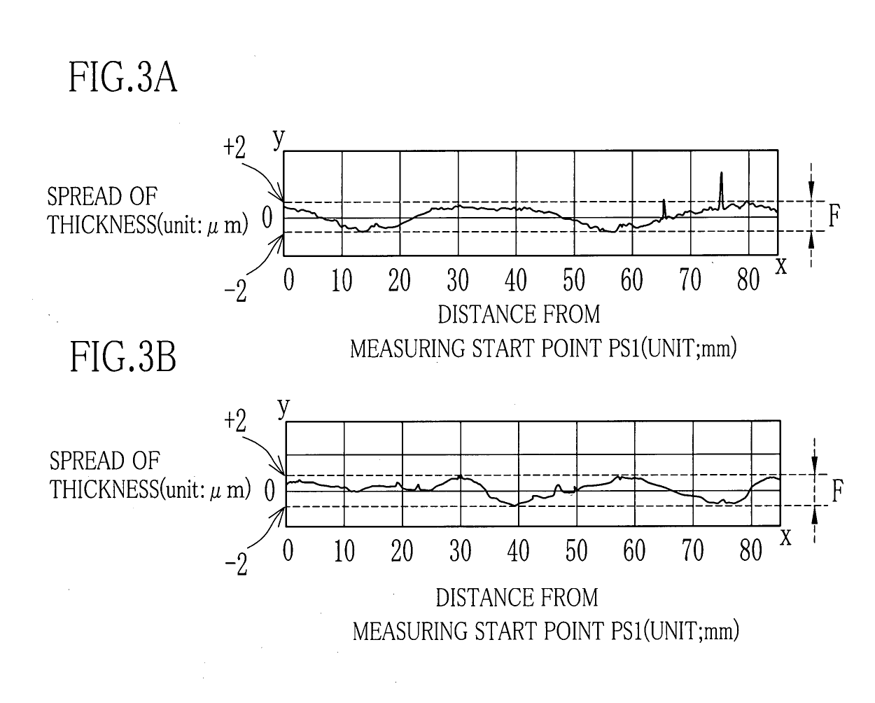

An example of thickness data of films in the present invention is shown in FIG. 3. A data of the film 81 is shown in FIG. 3(a), and a data of an other film is shown in FIG. 3(b). In both (a) and (b), y-axis means the spread of thickness (unit μm), Explanation of x-axis is omitted because it is similar to in FIG. 2. In y-axis, A line of the thickness average is regarded as zero line of the spread of the thickness. As shown in both (a) and (b) in FIG. 3, A band F of the spread for the thickness average of the film of the present invention is within ±2(μm) in the oblique direction. Note that the band F of the spread for the thickness average means a difference a maximum and a minimum in thickness. On the films, optical unevenness are reduced. So if these films are used in the LCD with big screen and high brightness, there is the effectiveness that a displaying unevenness doesn't generate.

And, in comparison between (a) and (b), peaks and bottoms emerge at almost same pitch in the both graphs, and the variance V of the rate of change at all each point is under 300×10⁻⁵. And if each of these films is used as a protective film of a polarizing filter in a LCD providing illuminator with brightness from 5000 to 50000 candela, the optical unevenness can't be observed and the LCD performs well in display in any cases. Note that in case of LCD providing illuminator with brightness under 5000 candela, prior film is applicapable without difficulty because the optical unevenness in a oblique direction isn't almost distinguished. Note that if this film is used in the LCD with illuminator with brightness over 50000 candela, there may be a difficulty with endurance.

A method of producing the film 81 is described in followings. But a method and an apparatus of production as described below are one example, and present invention is not restricted to the described below.

A cellulose acylate is used as a polymer in the embodiment of the present invention, and it is especially preferable that a triacetyl cellulose (TAC) is used as the cellulose acylate. The TAC made from both linter and pulp cotton is usable as this TAC. But the one from the linter cotton is preferably used. And in the cellulose acylate to be used in the present invention, the degree of the substitution preferably satisfies all of the following formulae (I)-(III). In these formulae, A is a degree of acyl substitution of the hydrogen atom of the hydroxyl group to the acetyl group, and B is a degree of substitution of the hydrogen group to the acyl group having 3-22 carbon atoms. Preferably, at least 90 wt. % of the cellulose acylate particles has diameter from 0.1 mm to 4 mm.
2.5≦A+B≦3.0 (I)
0≦A≦3.0 (II)
0≦B≦2.9 (III)

The cellulose is constructed of glucose units making β-1,4 combination, and each glucose unit has a liberated hydroxyl group at second, third and sixth positions. Cellulose acylate is a polymer in which part or whole of the hydroxyl groups are esterified so that the hydrogen is substituted by acyl groups. The degree of substitution for the acyl groups in cellulose acylate is a degree of esterification at second, third or sixth position in cellulose. Accordingly, when all (100%) of the hydroxyl group at the same position are substituted, the degree of substitution at this position is 1.

When the degrees of substitution for the acyl groups at the second, third or sixth positions are respectively described as DS1,DS2,DS3, the total degree of substitution for the acyl groups at the second, third or sixth positions (namely DS2+DS3+DS6) is preferably in the range of 2.00 to 3.00, more preferably in the range of 2.22 to 2.90, and particularly preferably in the range of 2.40 to 2.82. Further, DS6/(DS2+DS3+DS6) is preferably at least 0.32, and particularly at least 0.322, and especially in the range of 0.324 to 0.340.

The sort of acyl group to be contained in the cellulose acylate of the present invention is may be only one, and two or more sorts of the acyl group may be contained. If the number of the sorts of the acyl groups is at least two, it is preferable that one of the sorts is acetyl group. If the total degree of substitution for the acetyl groups and that for other acyl groups at the second, third or sixth positions are respectively is described as DSA and DSB, the value DSA+DSB is preferably in the range of 2.2 to 2.86, and particularly in the range of 2.40 to 2.80. Further, the DSB is preferably at least 1.50, and especially at least 1.7. Further, in substituents of the hydroxyl groups at second, third and sixth positions except of the acetyl groups, the percentage of these substituents at the sixth position is preferably at least 28%, particularly at least 30%, especially at least 31% and most especially at least 32%. Further, the degree of the acyl groups at sixth position is at least 0.75, particularly at least 0.80, and especially 0.85. When cellulose acylate satisfies the above conditions, a solution (or dope) having a preferable dissolubility can be prepared. Especially when non-chlorine type organic solvent is used, the adequate dope can be prepared, since the dope can be prepared so as to have a low viscosity and the filterability becomes higher.

The acyl group having at least 2 carbon atoms may be aliphatic group or aryl group, and is not restricted especially. As examples of the cellulose acylate, there are alkylcarbonyl ester, alkenylcarbonyl ester, aromatic carbonyl ester, aromatic alkylcalbonyl ester and the like. Further, the cellulose acylate may be also esters having other substituents. The preferably substituents are propionyl group, butanoyl group, keptanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group and the like. Among them, propionyl group, butanoyl group, dodecanoyl group, octadecanoyl group, t-butanoyl group, oleoyl group, benzoyl group, naphtyl carbonyl group, cinnamoyl group and the like are particularly preferable, and propionyl group and butanoyl group are especially preferable.

The present invention is applied to other polymer. For example, polyethylene terephthalate, polyethylene naphthalate, polyethylene, polymethacrylate, polycarbonate, produced cellulose ester, diacetyl cellulose, triacetyl cellulose, norbornene, polystylene, polyvinyl chloride, polyvinylidene chloride, polyvinyl alcohol, polyethel sulfone, polyetherketone, polyethylene, polypropylene, polyimide, polyamide or poly-4-methyl-1-pentene and the like. When a film is produced, selecting whether a solution casting method or a melt-extrusion method depends on kinds of polymer.

And solvent compounds for preparing the dope are aromatic hydrocarbon (for example, benzene toluene and the like), halogenated hydrocarbons (for example, dichloromethane, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, propylacetate and the like), ethers (for example tetrahydrofuran, methylcellosolve and the like) and the like. Note that the dope means the polymer solution or the dispersed solution obtained dissolving or dispersing the polymer in the solvent.

The preferable solvent compounds are the halogenated hydrocarbons having 1 to 7 carbon atoms, and dichloromethane is especially preferable. In view of physical properties such as optical properties, solubility, a peelability from a support, a mechanical strength of the film and the like, it is preferable to use at least one sorts of the solvent compounds having 1 to 5 carbon atoms. Then, the content of the alcohols is preferably in the range of 2% by mass to 25 by mass, and especially in the range of 5 by mass to 20 by mass to total solvent compounds in the solvent. As concrete example of the alcohols, there are methanol, ethanol, n-propanol, isopropanol, n-butanol, and the like. It is preferable to use methanol, ethanol, n-butanol or a mixture thereof.

Recently, in order to reduce the influence on the environment, the solvent containing no dichloromethane is proposed. In this case, the solvent contains ethers with 4 to 12 carbon atoms, ketones with 3 to 12 carbon atoms, esters with 3 to 12 carbon atom, or a mixture of them. The ethers, ketones, esthers may have a cyclic structure, and at least two solvent compounds having at least two functional groups thereof (—O—, —CO—, —COO—) may be contained in the solvent. In this case, the number of carbon atoms may be at most the above values for each compound of the functional group. Note that the organic solvent compound may have other functional group such as alcoholic hydroxyl group.

The cellulose acylate is described in detail in the Japanese patent application No. 2004-264464, and the description of this application can be applied to the present invention. Further, as the solvent of cellulose acylate and other additives, this application discloses plasticizers, deteoriation inhibitor, optical anisotropy controlling agent, dye, matting agent, peeling agent are in detail.

In the present invention, one or more UV-absorbing agent is preferable to be contained in the solution. Since having the dimensional stability, the cellulose acylate film is used in the polarizing filter, the liquid crystal display and the like. In view of the protection of the deterioration of liquid crystal compounds or a polarizing filter and the like, the UV-absorbing agent is preferably excellent in absorbing UV-ray whose wave length is equal or less than 370 nm. Further, in view of the displaying ability of the liquid crystal, the UV-absorbing agent preferably does not absorb visible ray whose wave length is equal or more than 400 nm. As the UV-absorbing agent, there are, for example, oxybenzophenone type compounds, benzotriasol type compounds, salicylic acid ester type compounds, benzophenone type compounds, cyanoacrylate type compounds, nickel complex salt type compounds.

As the preferable UV-absorbing agent, there are 2-(2′-hydroxy-5′-methylphenyl)benzotriazol; 2-(2′-hydroxy-3′,5′-di-tert-butylphenyl)benzotriazol; 2-(2′-hydroxy-3′-tert-butyl-5′-methylphenyl)benzotriazol; 2-(2′-hydroxy-3′,5′-di-tert-butylphenyl)-5-chlorobenzotriazol; 2-(2′-hydroxy-3′-(3″,4″,5″,6″-tetrahydrophthalimidomethyl)-5′-methylphenyl)benzotriazol; 2,2-methylenebis(4-(1,1,3,3-tetramethylbutyl)-6-(2H-benzotriazol-2-yl)phenol); 2-(2′-hydroxy-3′-tert-butyl-5′-methylphenyl)-5-chlorobenzotriazol; 2,4-dihydroxybenzophenone; 2,2′-dihydroxy-4-metoxybenzophenone; 2-hydroxy-4-metoxy-5-sulfobenzophenone; bis(2-metoxy-4-hydroxy-5-benzoylphenylmethane); (2,4-bis-(n-octylthio)-6-(4-hydroxy-3,5-di-tert-butylanylino)-1,3,5-triazine; 2-(2′-hydroxy-3′,5′-di-tert-butylphenyl)-5-chlorobenzotriazol; (2(2′-hydroxy-3′,5′-di-tert-amylphenyl)-5-chlorobenzotriazol; 2,6-di-tert-butyl-p-crezol; pentaerythrityl-tetrakis[3-(3,5-di-tert-butyl-4-hydroxyphenyl)propionate]; triethyleneglycol-bis[3-(3-tert-butyl-5-methyl-4-hydroxyphenyl)propionate]; 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triadine; 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-hexamethylenebis(3,5-di-tert-butyl-4-hydroxy-hydrocine amide), 1,3,5-trimethyl-2,4,6-tris(3,5-di-tert-butyl-4-hydroxybenzyl)benzene, tris-(3,5-di-tert-butyl-4-hydroxybenzyl)-isocianurate and the like. Especially preferable are 2,4-bis-(n-octylthio)-6-(4-hydroxy-3,5-di-tert-butylanylino)-1,3,5-triadine; 2(2′-hydroxy-3′,5′-di-tert-butylphenyl)-5-chlorobenzotriazol; (2(2′-hydroxy-3′,5′-di-tert-amylphenyl)-5-chlorobenzotriazol; 2-(2′-hydroxy-3′,5′-di-tert-butylphenyl)-5-chlorobenzotriazol; 2,6-di-tert-butyl-p-crezol, pentaerythrityl-tetrakis[3-(3,5-di-tert-butyl-4-hydroxyphenyl)propionate]; and triethyleneglycol-bis[3-(3-tert-butyl-5-methyl-4-hydroxyphenyl)propionate]. Further, the following compound can be used together; for example, metallic nonactivator of hydradine type, such as N,N′-bis[3-(3,5-di-tert-butyl-4-hydroxyphenyl)propionyl]hydradine, processing stabilizers of phosphor type, such as tris(2,4-di-tert-butylphenyl)phosphite and the like. The added amount of these compound is preferably 1 ppm to 2.0% in mass ratio to cellulose acylate, and particularly 10 ppm to 5000 ppm.

Further, it is preferable to use the UV-absorbing agents described in Japanese Patent Laid-Open Publications No. 6-148430 & 7-11056. The UV-absorbing agents preferably used in the present invention have high transparency and high efficiency for preventing the deterioration of the polarizing filter or the liquid crystal elements. Especially preferable are the benzotriazol type UV-absorbing agents which reduces the unnecessary coloring. The quantity of the UV-absorbing agent to be used in not constant and depending on the sorts of the compounds, the conditions of use and so on. However, the quantity is preferably in the range of 0.2 g to 5.0 g, and preferably in the range of 0.4 g to 1.5 g, and especially in the range of 0.6 g to 1.0 g in 1 m² cellulose acylate film.

As the UV-absorbing agents to be used in the present invention, there are optical stabilizer in catalogue of “Adekastab”, optical stabilizers and UV-absorbing agents in catalogue of Tinuvin of Ciba Special Chemicals, SEESORB, SEENOX, SEETEC and the like in catalogue of SHIPRO KASEI KAISHA. Further, there are VIOSORB of Kyodo Chem. Co. Ltd and UV-absorbing agents of Yoshitomi Pharmaceut Ind., Ltd.

Japanese Patent Laid-Open Publication No. 2003-043259 discloses the optical film to be used in the polarizing filter and the display device. The film is excellent in color reproducibility and endurance under the illumination of the UV-ray. In the UV-wavelength range, the spectral transmittance of the film is from 50% to 95% at 390 nm and at most 5% at 350 nm of UV-wave.

The compounds to be used as optical anisotropy controlling agents will be described in followings.

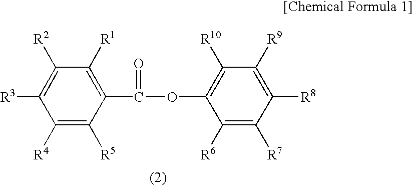

In the formula (2), R¹—R¹⁰ are independently hydrogen atom or substituent T which will be explained later. At least one of R¹—R⁵ is an electron donative substituent. The substituent having electron-donating property is preferably at least one of R¹,R³ and R⁵, and especially R³.

In the group having electron-donating property, a op value of Hammet is at most zero. The op value of Hammet described in Chem. Rev., 91,165(1991) is preferably at most zero, and especially in the range of −0.85 to 0. Such groups are, for example, alkyl groups, alkoxyl groups, amino groups, hydroxyl groups, and the like.

The groups having electron-donating property are preferably alkyl groups and alcoxy groups, and particularly alcoxy groups in which the number of carbon atoms is preferably from 1 to 12, particularly from 1 to 8, especially from 1 to 6, and more especially 1 to 4.

R¹ is preferably hydrogen atom or a substituent having electron-donating property, particularly alkyl group, alcoxy group, amino group and hydroxyl group, and especially alkyl group having 1-4 carbon atoms and alcoxy group having 1-12 carbon atoms. R¹ is more especially alcoxy group in which the number of carbon atoms is preferably from 1 to 12, particularly from 1 to 8, especially from 1 to 6, and more especially 1 to 4, and most especially methoxy group.

R² is preferably hydrogen atom, alkyl group, alcoxy group, amino group and hydroxyl group, particularly hydrogen atom, alkyl group and alcoxy group. R² is more especially hydrogen atom, alkyl group which has 1-4 carbon atoms or is further preferably methyl group, alcoxy group in which the number of carbon atoms is preferably from 1 to 12, particularly from 1 to 8, especially from 1 to 6, and more especially 1 to 4, and most especially methoxy group. The most especially group as R² is hydrogen atom, methyl group and methoxy group.

R³is preferably hydrogen atom or a substituent having electron-donating property, particularly hydrogen atom, alkyl group, alcoxy group, amino group and hydroxyl group, and especially alkyl group and alcoxy group. R³ is more especially alcoxy group in which the number of carbon atoms is preferably from 1 to 12, particularly from 1 to 8, especially from 1 to 6, and more especially 1 to 4. R³ is most especially n-propoxy group, ethoxy group and methoxy group.

R⁴ is preferably hydrogen atom or a substituent having electron-donating property, particularly hydrogen atom, alkyl group, alcoxy group, amino group and hydroxyl group, and especially hydrogen atom, alkyl group having 1-4 carbon atoms and alcoxy group having 1-12 carbon atoms. R⁴ is more especially alcoxy group in which the number of carbon atoms is preferably from 1 to 12, particularly from 1 to 8, especially from 1 to 6, and more especially 1 to 4. R⁴ is most especially hydrogen atom, methyl group, and methoxy group.

R⁵ is preferably hydrogen atom, alkyl group, alcoxy group, amino group and hydroxyl group, particularly hydrogen atom, alkyl group and alcoxy group. R⁵ is more especially hydrogen atom, alkyl group which has 1-4 carbon atoms or is further preferably methyl group, and alcoxy group in which the number of carbon atoms is preferably from 1 to 12, particularly from 1 to 8, especially from 1 to 6, and more especially 1 to 4. The most especially group as R⁵ is hydrogen atom, methyl group and methoxy group.

R⁶, R⁷, R⁹ and R¹⁰ preferably hydrogen atom, alkyl group having 1 to 12 carbon atoms, alcoxy group having 1 to 12 carbon atom and halogen atoms, particularly hydrogen atom and halogen atoms, and especially hydrogen atom.

R⁸ is preferably hydrogen atom, alkyl group having 1-4 carbon atoms, alkynyl group having 2-6 carbon atoms, aryl group having 6-12 carbon atoms, alcoxy group having 1-12 carbon atoms, and aryloxy group having 6-12 carbon atoms, alcoxy carbonyl group having 2-12 carbon atoms, acylamino group having 2-12 carbon atoms, ciano group and halogen atom. These groups may have a substituent T which will be explained later.

R⁸ is preferably alkyl group having 1-4 carbon atoms, alkynyl group having 2-6 carbon atoms, aryl group having 6-12 carbon atoms, alcoxy group having 1-12 carbon atoms, aryloxy group having 2-12 carbon atoms, and more preferably aryl group having 6-12 carbon atoms, alcoxy group having 1-12 carbon atoms, aryloxy group having 6-12 carbon atoms. R⁸ is preferably alcoxy group in which the number of carbon atoms is preferably from 1 to 12, particularly from 1 to 8, especially from 1 to 6, and more especially 1 to 4. The most especially group as R⁸ is methoxy group, ethoxy group, n-propoxy group, iso-propoxy group and n-butoxy group.

In Chemical Formula 1 (formula (2)), there are preferable compounds shown in Chemical Formula 2 (following formula.

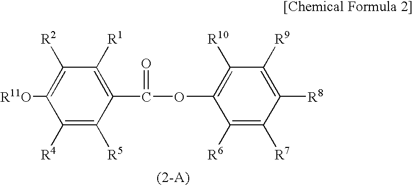

In the formula (2-A), R¹¹ is alkyl group, and R¹,R²,R⁴—R⁷, R⁹,R¹⁰ are independently hydrogen atom or substituents. R⁸ is hydrogen atom, alkyl group having 1-4 carbon atoms, alkynyl group having 2-6 carbon atoms, aryl group having 6-12 carbon atoms, alcoxy group having 1-12 carbon atoms, aryloxy group having 6-12 carbon atoms, alcoxy carbonyl group having 2-12 carbon atoms, acylamino group having 2-12 carbon atoms, ciano group and halogen atom. In Chemical Formula 2 (formula (2-A)), R¹,R²,R⁴—R¹⁰ and the preferable range of the number of the carbon atoms in one molecule are the same as in Chemical Formula 1 (formula (2)).

In formula (2-A), R¹¹ is preferably alkyl group having 1-12 carbon atoms, and may have straight chain or branched chain. Further, R¹¹ may have substituents and be preferably alkyl group having 1-12 carbon atoms, particularly alkyl group having 1-8 carbon atoms, especially alkyl group having 1-6 carbon atoms, and more especially alkyl group having 1-4 carbon atoms (for example, methyl group, ethyl group, n-propyl group, iso-propyl group, n-butyl group, iso-butyl group, tert-butyl group and the like.

In Chemical Formula 1 (formula (2)), there are preferable compounds shown in Chemical Formula 3 (following formula (2-B)).

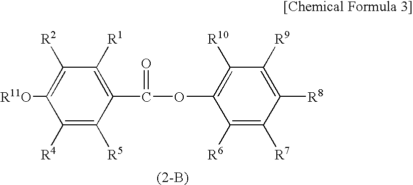

In the formula (2-B), R¹,R²,R⁴—R⁷,R⁹,R¹⁰ are independently hydrogen atom or substituents. R¹¹ is a alkyl group having 1 to 12 carbon atoms. X is alkyl group having 1-4 carbon atoms, alkynyl group having 2-6 carbon atoms, aryl group having 6-12 carbon atoms, alcoxy group having 1-12 carbon atoms, aryloxy group having 6-12 carbon atoms, alcoxy carbonyl group having 2-12 carbon atoms, acylamino group having 2-12 carbon atoms, ciano group and halogen atom.

In Chemical Formula 3 (formula (2-B)), R¹,R², R⁴—R⁷,R⁹,R¹⁰ and the preferable range of the number of the carbon atoms in one molecule are the same as in Chemical Formula 1 (formula (2)), and R⁸ and the preferable range of the number of the carbon atoms in one molecule are the same as in Chemical Formula 2 (formula (2-A)).

In Chemical Formula 3 (formula (2-B)), X is alkyl group having 1-4 carbon atoms, alkynyl group having 2-6 carbon atoms, aryl group having 6-12 carbon atoms, alcoxy group having 1-12 carbon atoms, aryloxy group having 6-12 carbon atoms, alcoxy carbonyl group having 2-12 carbon atoms,and acylamino group having 2-12 carbon atoms, ciano group and halogen atom

If R¹,R²,R⁴,R⁵ are hydrogen atoms, X is preferably alkyl group, alkynyl group, aryl group, alcoxy group, aryloxy group, and particularly aryl group, alkoxy group, aryloxy group, especially alcoxy group in which the number of carbon atoms is preferably from 1 to 12, particularly from 1 to 8, especially from 1 to 6, and more especially 1 to 4. The most especially preferable group as X is methoxy group, ethoxy group, n-propoxy group, iso-propoxy group and n-butoxy group.

If at least one of R¹,R²,R⁴ and R⁵ is substituent, X is preferably alkynyl group, aryl group, alcoxy carbonyl group and ciano group, and preferably aryl group having 6-12 carbon atoms, alcoxy carbonyl group having 2-12 carbon atoms and ciano group. Further, X is especially preferably ciano group, aryl group which has 6-12 carbon atoms (particularly phenyl group, p-cianophenyl group and p-methoxyphenyl group), alcoxycarbonyl group which has preferably 2-12, particularly 2-6 and especially 2-4 carbon atoms and is especially methoxy carbonyl group, ethoxy carbonyl group and n-propoxycarbonyl group. The most especially group as X is phenyl group, methoxy carbonyl group, ethoxy carbonyl group, n-propoxy group and cyano group.

In Chemical Formula 1 (formula (2)), there are preferable compounds shown in Chemical Formula 4 (following formula (2-C)).

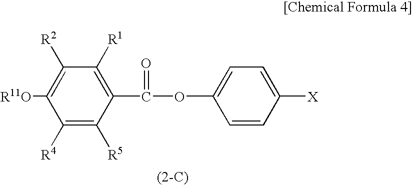

In Chemical Formula 4 (formula (2-C)), R¹,R²,R⁴,R⁵,R¹¹ and the preferable range of the number of the carbon atoms in one molecule are the same as in Chemical Formula 3 (formula (2-B)).

In Chemical Formula 1 (formula (2)), there are preferable compounds shown in Chemical Formula 5 (following formula (2-D)).

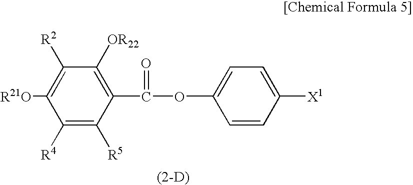

In Chemical Formula 5 (formula (2-D)), R²,R⁴,R⁶ and the preferable range of the number of the carbon atoms in one molecule are the same as in Chemical Formula 4 (formula (2)). R²¹,R²² are independently alkyl group having 1-4 carbon atoms. X¹ is aryl group having 6-12 carbon atoms, alcoxylcarbonyl group having 2-12 carbon atoms, or cyano group.

R²¹ is alkyl group having 1-4 carbon atoms, preferably alkyl group having 1-3 carbon atoms, and particularly methyl group and ethyl group. R²² is alkyl group having 1-4 carbon atoms, preferably alkyl group having 1-3 carbon atoms, particularly methyl group and ethyl group, and especially methyl group.

X¹ is aryl group having 6-12 carbon atoms, alcoxyl carbonyl group having 2-12 carbon atoms, and cyano group, and preferably aryl group having 6-10 carbon atoms, alcoxyl carbonyl group having 2-6 carbon atoms, and cyano group. X¹ is especially preferably phenyl group, p-cianophenyl group, p-methoxyphenyl group, methoxycarbonyl group, ethoxy carbonyl group, n-propoxy carbonyl group, and cyano group, and more especially phenyl group, methoxycarbonyl group, ethoxycarbonyl group, n-propoxycarbonyl group, and cyano group.

In Chemical Formula 1 (formula (2)), there are preferable compounds shown in Chemical Formula 6 (following formulae (2-E1),(2-E2),(2-E3)).

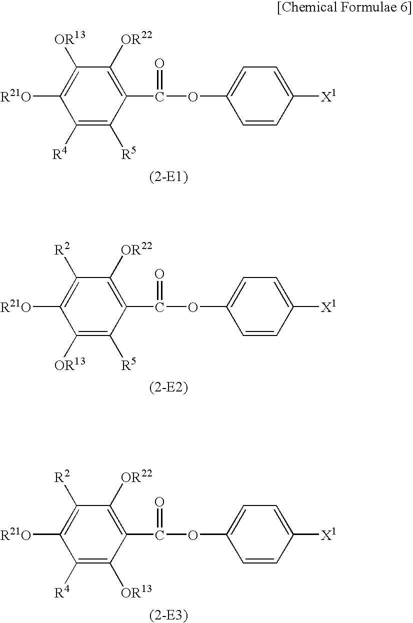

In Chemical Formula 6 (formulae (2-E1), (2-E2), (2-E3)), R²,R⁴,R⁵ and the preferable range of the number of the carbon atoms in one molecule are the same as in Chemical Formula 5 (formula (2-D)). As shown in Chemical Formulae 6, OR¹³ is substituent for one of R²,R⁴,R⁵, and R¹³ is alkyl group having 1-4 carbon atoms. R²¹,R²²,X¹ and the preferable range of the number of the carbon atoms in one molecule are the same as in Chemical Formula 5 (formula (2-D)).

Preferably, both R⁴ and R⁵ are OR¹³, and especially R⁴ is OR¹³. R¹³ is alkyl group having 1-4 carbon atoms, preferably alkyl group having 1-3 carbon atoms, particularly methyl group and ethyl group, and especially methyl group.

In followings, the substituents T will be explained. As the substituents, there are, for example, alkyl groups in which the number of the carbon atoms is preferably from 1 to 20, particularly from 1 to 12, especially from 1 to 8. Concretely, the alkyl group is methyl group, ethyl group, iso-propyl group, tert-butyl group, n-octyl group, n-decyl group, n-hexadecyl group, cyclopropyl group, cyclopentyl group, cyclohexyl group and the like. Further, as the substutuents, there are, for example, alkenyl groups in which the number of the carbon atoms is preferably from 2 to 20, particularly from 2 to 12, especially from 2 to 8 (concretely, vinyl, aryl group, 2-butenyl group, 3-pentenyl group and the like), alkynyl groups in which the number of the carbon atoms is preferably from 2 to 20, particularly from 2 to 12, especially from 2 to 8 (concretely, propargyl group, 3-pentynyl group and the like).

Further, as the substutuents, there are, for example, aryl groups in which the number of the carbon atoms is preferably from 6 to 30, particularly from 6 to 20, especially from 6 to 12. Concretely there are phenyl group, p-methylphenyl group, naphtyl group and the like. Furthermore, as the substutuents, there are, for example, substituted or non-substituted amino groups in which the number of the carbon atoms is preferably from 0 to 20, particularly from 0 to 10, especially from 0 to 6. Concretely, there are amino group, methylamino group, dimethylamino group, diethylamino group, dibenzylamino group, and the like.

Further, as the substutuents, there are acyl groups in which the number of the carbon atoms is preferably from 1 to 20, particularly from 1 to 16, especially from 1 to 12. Concretely, there are acetyl group, benzoyl group, formyl group, pivaloyl group, and the like. Further, as the substutuents, there are alcoxy carbonyl groups in which the number of the carbon atoms is preferably from 2 to 20, particularly from 2 to 16, especially from 2 to 12. Concretely, there are methoxycarbonyl group, ethoxycarbonyl group and the like. Further, as the substutuents, there are aryloxycarbonyl groups in which the number of the carbon atoms is preferably from 7 to 20, particularly from 7 to 16, especially from 7 to 10. Concretely, there are phenyloxycarbonyl group and the like. Further, as the substutuents, there are acyloxy groups in which the number of the carbon atoms is preferably from 2 to 20, particularly from 2 to 16, especially from 2 to 10. Concretely, there are acetoxy group, benzoyloxy group and the like.

Further, as the substutuents, there are acylamino groups in which the number of the carbon atoms is preferably from 2 to 20, particularly from 2 to 16, especially from 2 to 10. Concretely, there are acetylamino group, benzoylamino group and the like. Further, as the substutuents, there are alcoxycarbonylamino groups in which the number of the carbon atoms is preferably from 2 to 20, particularly from 2 to 16, especially from 2 to 12. Concretely, there are methoxycarbonylamino group and the like. Further, as the substutuents, there are aryloxycarbonylamino groups in which the number of the carbon atoms is preferably from 7 to 20, particularly from 7 to 16, especially from 7 to 12. Concretely, there are phenyloxycarbonylamino group and the like. Further, as the substutuents, there are sulfonylamino groups in which the number of the carbon atoms is preferably from 1 to 20, particularly from 1 to 16, especially from 1 to 12. Concretely, there are methanesulfonyl amino group, benzene sulfonylamino group and the like.

Further, as the substutuents, there are sulfamoyl groups in which the number of the carbon atoms is preferably from 0 to 20, particularly from 0 to 16, especially from 0 to 12. Concretely, there are sulfamoyl group, methylsulfamoyl group, dimethylsulfamoyl group, phenylsulfamoyl group and the like. Further, as the substutuents, there are carbamoyl groups in which the number of the carbon atoms is preferably from 1 to 20, particularly from 1 to 16, especially from 1 to 12. Concretely, there are carbamoyl group, methylcarbamoyl group, diethylcarbamoyl group, phenylcarbamoyl group and the like. Furthermore, as the substutuents, there are alkylthio groups in which the number of the carbon atoms is preferably from 1 to 20, particularly from 1 to 16, especially from 1 to 12. Concretely, there are methylthio group, ethylthio group and the like. Furthermore, as the substutuents, there are arylthio groups in which the number of the carbon atoms is preferably from 6 to 20, particularly from 6 to 16, especially from 6 to 12. Concretely, there are phenylthio group.

Further, as the substutuents, there are sulfonyl groups in which the number of the carbon atoms is preferably from 1 to 20, particularly from 1 to 16, especially from 1 to 12. Concretely, there are mesyl group, tosyl group and the like. Further, as the substutuents, there are sulfinyl groups in which the number of the carbon atoms is preferably from 1 to 20, particularly from 1 to 16, especially from 1 to 12. Concretely, there are methane sulfinyl group, benzene sulfinyl group and the like. Further, as the substutuents, there are ureido groups in which the number of the carbon atoms is preferably from 1 to 20, particularly from 1 to 16, especially from 1 to 12. Concretely, there are ureido group, methylureido group, phenylureido group and the like. Furthermore, as the substutuents, there are phosphoric acid amide groups in which the number of the carbon atoms is preferably from 1 to 20, particularly from 1 to 16, and especially from 1 to 12. Concretely, there are diethylphosphoric acid amide group, phenylphosphoric acid amide group and the like.

Further, as the substutuents, there are hydroxyl groups, mercapto groups, halogene atoms (fluorine atom, chlorine atom, bromine atom, iodine atom an the like), cyano groups, sulfo groups, carboxyl group, nitro group, hydroxsamic acid group, sulfino group, hydrazino group, imino group, heterocyclic group in which the number of the carbon atoms is preferably from 1 to 30, particularly from 1 to 12 and there are nitrohgen atom, oxygen atom, sulfer atom and the like as the hetoroatom. As the hetetocyclic group, for example, there are imidazolyl group, pyridyl group, quinoryl group, furyl group, piperidyl group, morphorino group, benzooxazolyl group, benzimidazolyl group, benzthiazolyl group and the like. Further, as the substutuents, there are silyl group in which the number of the carbon atoms is preferably from 3 to 40, particularly from 3 to 30 and especially from 3 to 24, and there are trimethyl silyl, triphenyl silyl and the like. In the substituents, the subsitution may be further made. When there are two or more substituents, the sorts thereof may be the same or different. nitroten atom, oxygen atom sulfer atom and the like as the hetoroatom. Father, the subsistent may form a cyclic group.

In followings chemical formulae, concrete examples of the compounds shown in Chemical formula 1 (formula (2)) will be illustrated. However, the present invention is not restricted in the concrete examples.

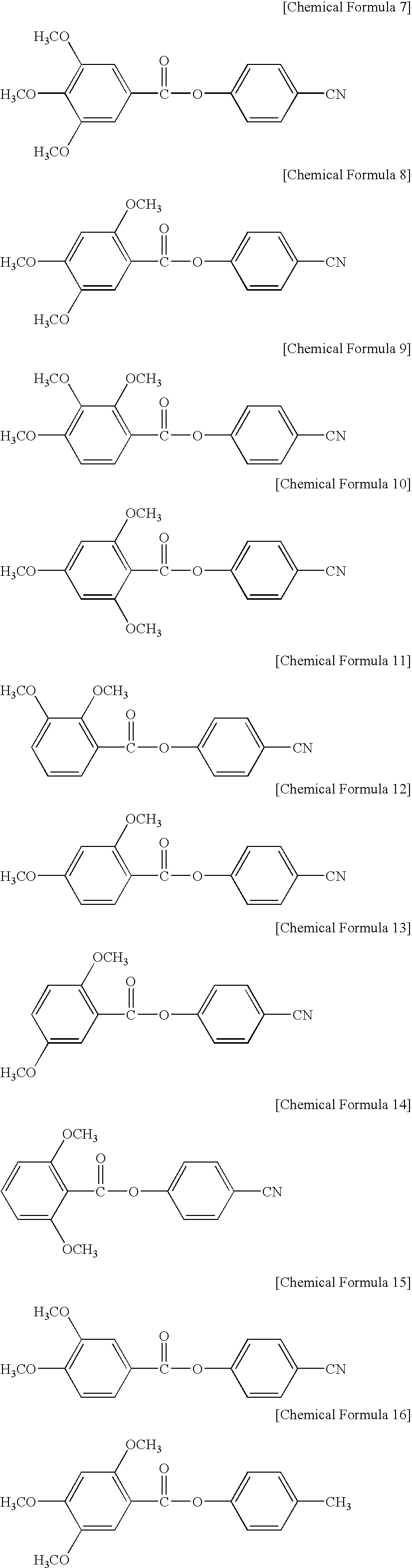

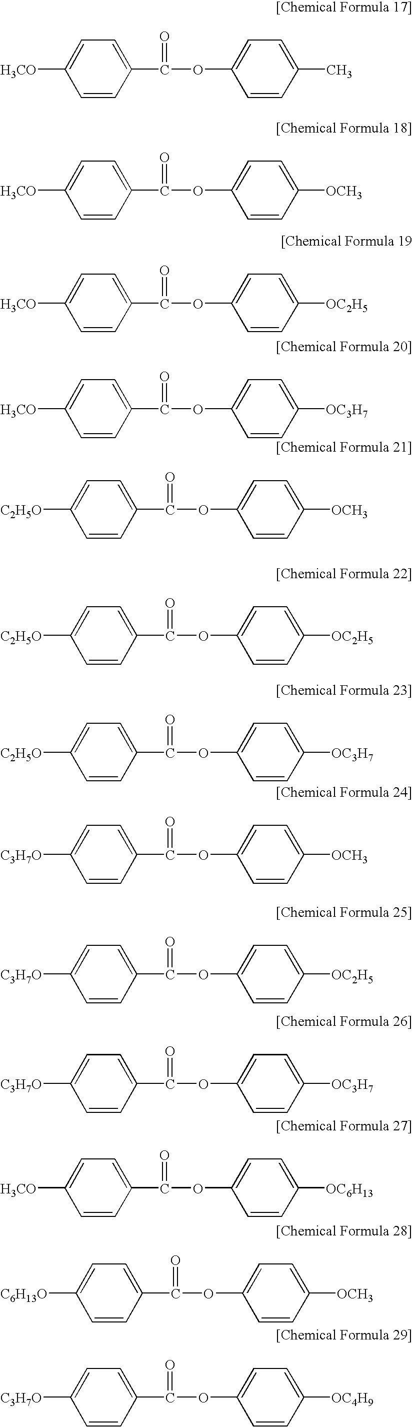

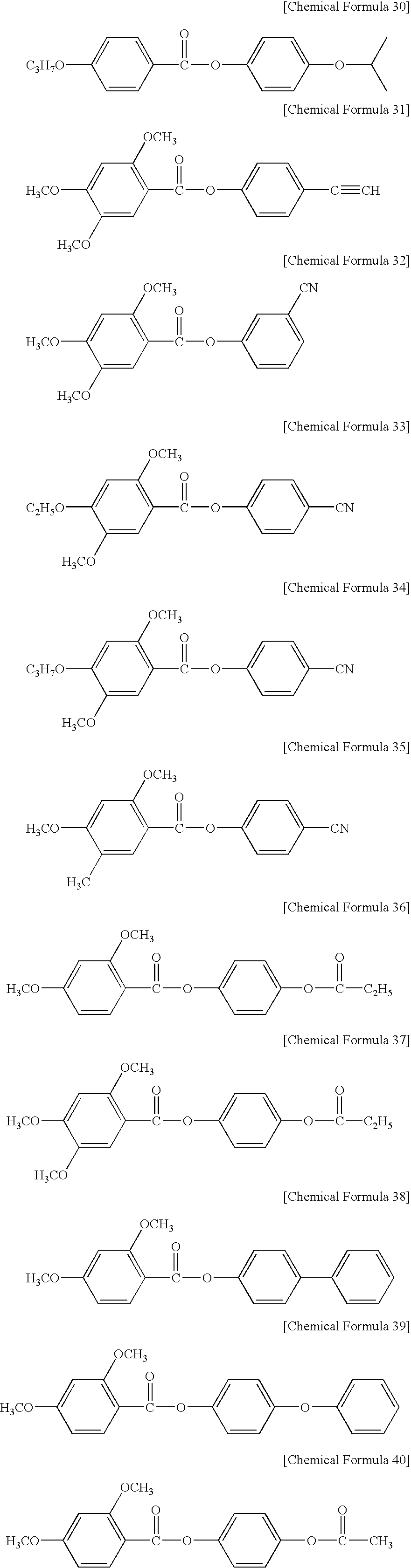

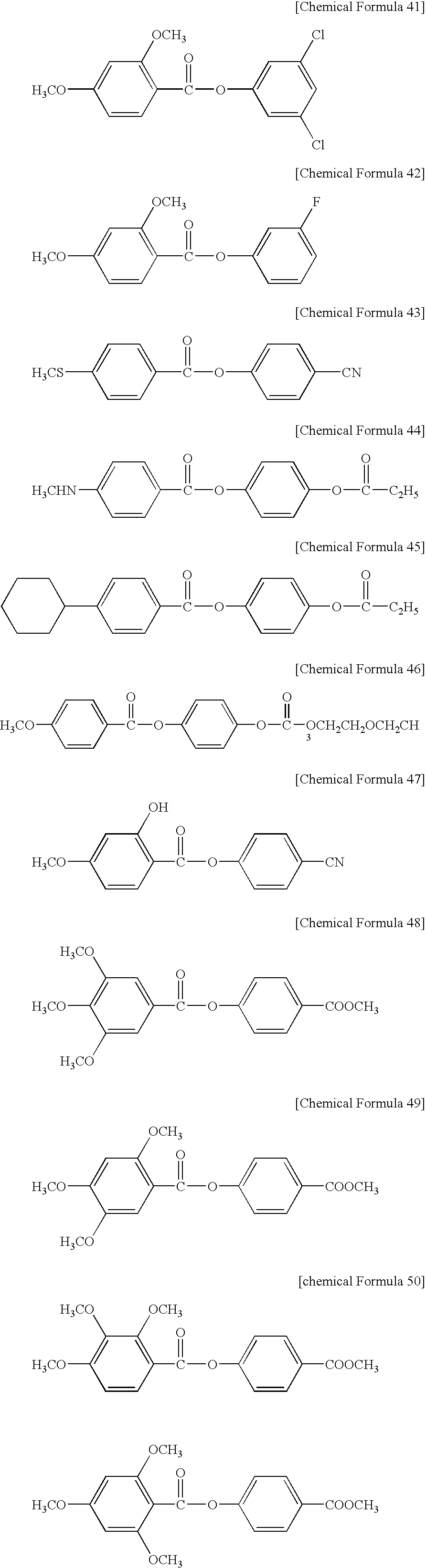

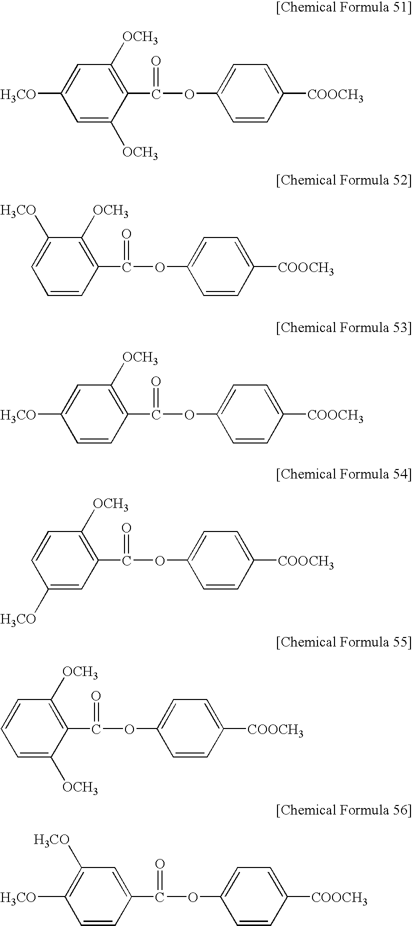

The compounds represented by Chemical Formula 1 (formula (2)) can be produced in a general esterification reaction of substituted benzoic acid and phenol derivatives. The method of the production is not restricted so far as being esterification reaction. For example, there are a method in which a functional group transformation of the substituted benzoic acid to an acid halide is made and thereafter a condensation with the phenol is made, a method in which the dehydration condensation between substituted benzoic acid and the phenol derivatives with use of condensation agent and catalyst, and the like. In consideration of the producing process, the method in which the phenol condensation is made after the functional group transformation of the substituted benzoic acid to the acid halide.

As the solvent for the reaction, there are hydrocarbon type solvent (preferably toluene, xylene and the like), ether type solvent (preferably dimethylether, tetrahydrofuran, dioxane and the like), ketone type solvent, ester type solvent, acetonitril, dimethylformamide, dimethylacetoamide and the like. Single one or the mixture of these compounds may be used as the solvent. Especially preferable solvents are toluene, acetonitril, dimethylformaldehyde, dimethylacetoamide and the like.

The reaction temperature is preferably in the range of 0° C. to 150° C., particularly in the range of 0° C. to 100° C., especially in the range of 0° C. to 90° C., and more especially 20° C. to 90° C. In this reaction, it is preferable not to use a base. When the base is used, the organic and inorganic bases may be used. However, the organic base is preferably used, and pyridine and tertiary alkylamine (preferably triethylamine, ethyldiisopropyl amine and the like) are particularly preferably used.

In the optical properties of celluloseacylate film of the present invention, retardation values Re,Rth are represented by formulae (IV),(V):
Re(λ)=(nx−ny)×d; Formula (IV):
Rth(λ)={(nx+ny)/2−nz)×d Formula (V):
The retardation values Re,Rth preferably satisfy following formulae (VI),(VII):
46 nm≦Re(630)≦200 nm; Formula (VI):
70 nm≦Rth(630)≦350 nm; Formula (VII):
[In formulae, Re(λ) is an in-plane retardation value (unit;nm) at λnm wavelength, Rth(λ) is a retardation value (unit;nm) in a thickness direction at λnm wavelength. Further, nx is a refractive index in the direction of the slow axis on a film surface, ny is a refractive index in the direction of the fast axis on a film surface, and nz is a refractive index in the thickness direction of the film. Further, d is the film thickness.]
The retardation values especially preferably satisfy following formulae (VIII),(XI):
46 nm≦Re(630)≦100 nm; Formula (VIII):
180 nm≦Rth(630)≦350 nm; Formula (XI):

The optical properties such as the retardation values Re,Rth change depending on a humidity variation, a mass variation and a period in which the high temperature is kept. Preferably, the change of the values Re,Rth are smaller. In order to reduce the change of the values Re,Rth, the moisture permeability and the equilibrium moisture content of the film is made smaller by using not only cellulose acylate whose degree of acylation at 6^{th} position is large, but also several sorts of hydrophobic additives (plasticizer, retardation controller, UV-absorbing agent and the like). The moisture permeability to cellulose acylate is preferably from 400 g to 2300 g in 1 square meter at 60° C. and 95% RH for 24 hours. The measured value of the equilibrium moisture content is preferably at most 3.4% at 25° C. and 80% RH. When the humidity at 25° C. varies from 10% RH to 80% RH, the retardation values Re,Rth of the optical properties respectively change at most 12 nm and at most 32 nm. The quantity of the hydrophobic additives is preferably from 10% to 30%, particularly from 12% to 25%, and especially 14.5% to 20%. If the additives is volatile and resoluble compounds, the mass variation and size variation of the film occur, which causes the change of the optical properties. Accordingly, after 48 hours passes at 80° C. and 90% RH, the mass variation of the film is preferably at most 5%. Similarly, after 24 hours passes at 60° C. and 95% RH, the size variation of the film is preferably at most 5%. Further, event though the size variation and the mass variation are small, the change of the optical properties becomes smaller under the smaller photoelastic coefficient. Therefore, the photoelastic coefficient is preferably at most 50×10⁻¹³ cm²/dyne.

The producing method of the dope used in the present invention is not restricted especially. An example of the producing method will be described in followings. The main solvent compound is dichloromethane, and the mixture solvent into which the alcohols are added was used. TAC and the plasticizers are added to the mixture solvent, and the dissolution with the stirring is made to obtain a primary dope. Note that in the dissolving, the heating and the cooling were made so as to increase the dissolubility. Further, the primary dope, the mixture solvent and the UV-absorbing agent (for example, benzotriazol type compound) are mixed and stirred to obtain an additive solution. Further, the primary dope, the mixture solvent and the matting agent are mixed and dispersed to obtain a matting liquid. Further, as to the object, an additive liquid containing the deterioration inhibitors, optical anisotropy controlling agent, a dye and a peeling agent may be prepared.

[Method of Producing the Dope]

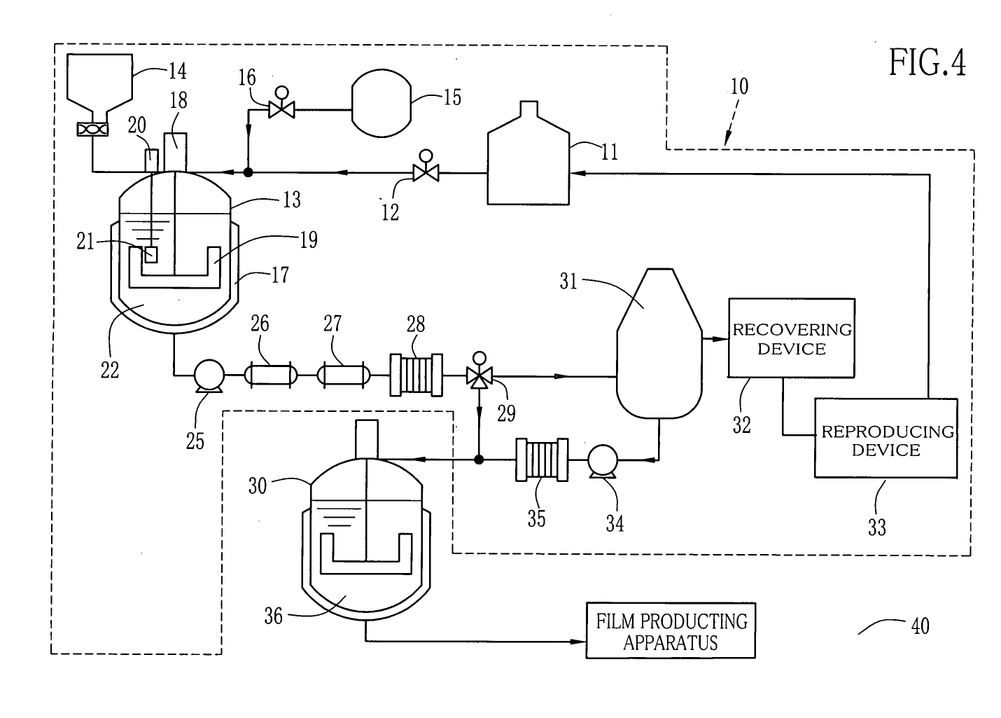

First, the dope is made from above raw materials. A dope producing apparatus 10, which is described in FIG. 4, comprises a solvent tank 11 containing a solvent, a dissolving tank 13 for mixing the solvent and TAC, a hopper 14 for supplying TAC and a additive tank 15, further a heater 26 for heating a swelling liquid as described below, a regulator 27 for regulating the temperature of the heatened swelling liquid, filtration devices 28, 35, a flushing device 31 for adjusting the concentration of the dope. And, the dope producing apparatus 10 comprises a recovering device 32 for recovering the solvent and a reproducing device 33 for reproducing the recovered solvent. And this dope producing apparatus 10 is connected to a film producing apparatus 40 through a stock tank 30.

In the embodiment of the present invention, the dope is made in the dope producing line 10 by a method in the followings. First a solvent is transported from the solvent tank 11 to the dissolving tank 13 by opening a valve 12. Next, TAC in the hopper 14 is transported into the dissolving tank 13 with the volume of TAC measured, and additive liquid are transported from the additive tank 15 to the dissolving tank 13 with some needed volume being modulated by opening and closing a valve 16.

There are other methods except for additives to be transported as a solution. For example, it is possible that the additive in the form of a liquid is transported into the dissolving tank 13 if additives are in liquid state at the normal temperature. If the additive is in solid state, it is also possible that additive in the form of a solid is transported into the dissolving tank 13 by hopper and the like. If several kinds of additives are used, a solution dissolving them can be stored in the additive tank 15 containing additives, and can be transported into the dissolving tank 13 via each closed pipes.

An order at which materials transported into a dissolving tank 13 as described above is that solvent is first TAC is second, additives is third. But the order is not restricted to this way. For example, after TAC is transported into the dissolving tank 13 with the volume measured, the preferable volume of a solvent can be transported. And, additives don't have to be transported ahead into the dissolving tank 13 but can be mixed into TAC and solvent at the after process. (The mixed one is often also called a dope below.)

The dissolving tank 13 comprises a jacket 17 which covers the outside of the tank 13 as shown in FIG. 4 and a first stirrer 19 rotated by a motor 18. Further, preferably the dissolving tank 13 comprises a second stirrer 21 rotated by a motor 20 as shown in FIG. 4. Note that preferably the first stirrer 19 is with a anchor blade and the type of the second stirrer 21 is with a decentering stirrer of dissolver type. And in an embodiment of the present invention, temperature of the dissolving tank 13 is regulated by flowing a heating midiuminside the jacket 17. The temperature is preferably in the range of −10° C. to 60° C. by selecting the type of the first stirrer 19 or the second stirrer 21 and using then a swelling liquid 22 in which the TAC swells in the solvent is made.

Next, the swelling liquid 22 is transported into the heater 26 by a pump 25. Preferably, the heater 26 is a pipe with a jacket. Further, preferably the structure of the heater 26 is in which the swelling liquid 22 can be pressured. Thus a solid component in the swelling liquid 22 is dissolved under heating or under heating and pressure. Note that preferably the temperature in swelling and dissolving is from 0° C. to 97° C. And a well-known method of the cooling dissolution is applicapable to cooling the swelling liquid 22 to the temperature of −100° C. to −10° C. without the heater 26. It is possible that TAC is dissolved in a solvent enough by selecting and using the cooling or heating dissolution method appropriately. A temperature of the dope is led to a room temperature, and next the dope is filtrated by the filtration device 27 so that impurities are removed from the dope. Preferably the average of pore diameter of a filter in a filtration device 28 is less than 100(μm). Preferably the volume of the filtrating flux is more than 50 liter/hour. The dope after the filtration is stored into the stock tank 30 via a valve 29.

As above mentioned, the method that once the swelling liquid 22 is prepared and then making the solution from the swelling liquid 22 have a problem in terms of product cost in some cases because the higher the concentration of TAC is made, the longer time is to be needed. In this case, preferably after a dope is prepared less at concentration than at objective one, the concentration process is made in such that the concentration of the dope is made from low to objective when the process like this is made, the dope filtrated in the filtration device 28 is transported into the flushing device 31 via the valve 29, so a part of solvent in the dope flushing device is vaporized in the flushing device 31. The solvent vapor are condensed into liquid by the condenser(not shown). This liquid is recovered by the recovering device 32 and the recovered solvent is reproducing by the reproducing device 33 to reuse as a solvent for preparing a dope. This recycling process performs well in terms of costs.

And a condensed dope 36 is drawn from the flushing device 31 out by a pump 34. Further, preferably the air bubble generated in the dope 36 is removed by a certain treatment. The various kinds of prior methods to remove the air bubble are applicapable. For example, the ultrasonic irradiation method. Next, a dope 36 is transported to the filtration device 35 and to remove impurities therefrom. Note that preferably the temperature of the dope 36 is from 0° C. to 200° C. The dope 36 is transported and stored into the stock tank 30. And the dope in a stock tank 30 is transported into a film producing apparatus 40.

Preferably additive liquid and the other material liquid are mixed by an inline mixer while transporting, for example a static mixer. And, the method for mixing is mixing with connecting serially plural inline mixers in different ways for mixing.

Preferably one of at least either a static mixer or sulzer mixer is used as an inline mixer. In case that a static mixer is used, the mixer preferably has 6 to 9 elements and more preferably 6 to 60 elements.

Preferably in case that both a static mixer and sulzer mixer are equipped, sulzer mixer is disposed in upstream side from the static mixer. Further, preferably the distance is from 5 mm to 150 mm between sulzer mixer and the orifice for additive liquid to flow into. Further, more preferably the distance is from 5 mm to 15 mm between sulzer mixer and the orifice for additive liquid to flow into. And, preferably the most upstream one of the elements in a sulzer mixer are disposed near the inside of the pipe in which the above raw material dope flows through filtrating.

Further, preferably the first filtration device the raw material dope is disposed in the upstream side from the inline mixer and the additives are mixed into the dope filtrated by the first filtration device. Further, more preferably the second filtration device filtrating the dope is disposed in the downstream from the inline mixer, and the dope mixed by the inline mixer is filtrated by the second filtration device.

Preferably the present invention is performed so as to satisfy the following condition.

(1) 1≦V1/V2≦5 when V1 is defined as a velocity of flow of the additive liquid and V2 is defined as the velocity of flow of the raw material liquid

(2) the ratio of the additive liquid is from 0.1% to 50% by the flow volume

(3) 1000≦N2/N1≦10000 is satisfied when N1 is defined as the viscosity of additive liquid and N2 is defined as the viscosity of the raw material liquid, and also 5000 cP≦N1≦500000 cP and 0.1 cP≦N2≦100 cP at 20° C.

(4) The shear rate of the raw material dope is from 0.1(1/s) to 30(1/s)

(5) The polymer is cellulose acylate.

(6) The additive liquid is a solution containing the main solvent of polymer solution

(7) The additive liquid is the solution containing the main solvent of the dope, and the composition of the additives is different from the raw material liquid.

(8) The additive liquid is the solution including the main solvent of the dope, and including at least one kind of UV absorbing agents

(9) The additive liquid is the solution including the main solvent of dope, and is comprised in dispersed particles of at least one kind of inorganic or organic material.

(10) The additive liquid is the solution including the main solvent of dope, and includes at least one kind of peeling aids agent.

(11) The additive liquid is the solution including the main solvent of dope, and includes at least one kind of poor solvent.

The dope in which TAC concentration is from 5% by mass to 40% by mass can be produced by the preceding method. Note that methods for dissolving materials, raw materials and additive, filtrating, removing the bubble, and adding in the solution casting method for producing TAC film are explained in Japanese Patent Application No. 2004-264464. The content of this publication can be applied to the present invention.

[Solution Casting Method]

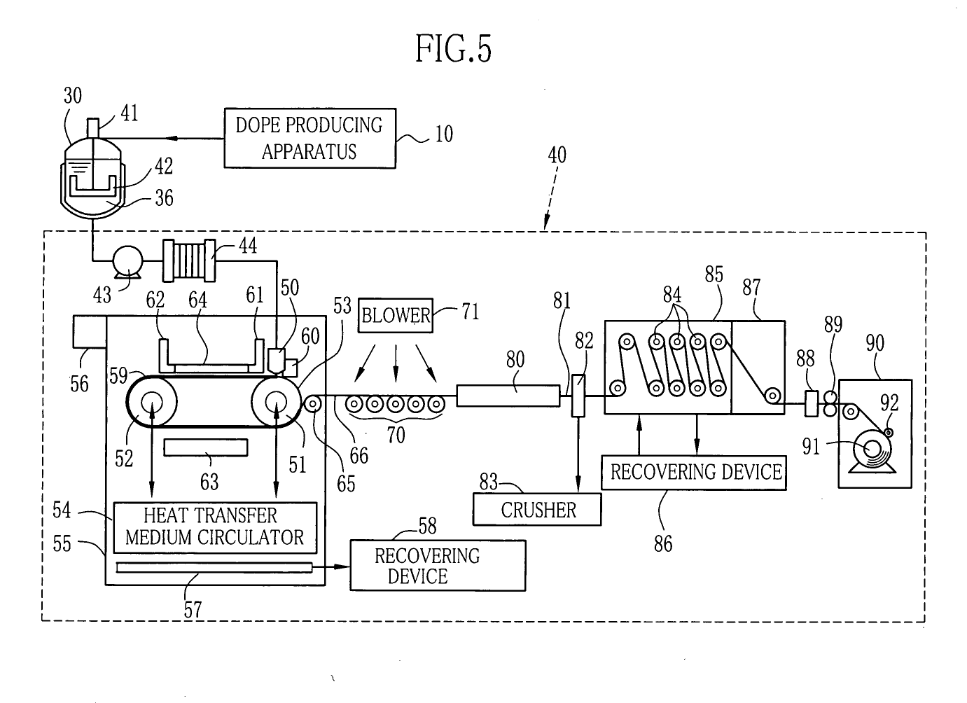

A method for producing film from the dope 36 obtained as described above. But, the present invention is not restricted to the apparatus in FIG. 5. The film producing apparatus 40 comprises a filtration apparatus 44, a casting die 50, a casting belt 53 supported by rollers 51, 52, and a tenter 80 an edge slitting device 82, a drying chamber 85 and a cooling chamber 87 and winding chamber 90.

A stirrer 42 rotated by a motor 41 is provided in the stock tank 30. And, this stock tank 30 is connected to the casting die 50 through a pump 43 and the filtration device 44.

Preferably the material of the casting die 50 was a precipitation hardened stainless or a stainless having double-phase structure. Preferably the material had coefficient of thermal expansion of at most 2×10⁻⁵(°C.⁻¹), the almost same anti-corrosion properties as SUS316 in examination of corrosion in electrolyte solution. Further, when the material was dipped in a mixture liquid of dichloromethane, methanol and water, pitting (holes) were not formed on the gas-liquid interface. Furthermore, preferably the casting die 50 is made by grinding after one month have passed since casting process. The casting die 50 keep the surface of the dope, which flows, in the casting die 50 constant. The finish precision of a contacting surface of the casting die 50 to the dope was at most 1 μm in surface roughness and at most 1 μm/m in straightness in any directions, and the clearance of the slit was automatically controlled in the range of 0.5 mm to 3.5 mm. An end of the contacting portion of each lip to the dope was processed so as to have a chamfered radius at most 50 μm through the slit. In the die, the shearing speed is preferably in the range of 1(1/sec) to 5000(1/sec).

Preferably the casting die 50 to be used is about from one to twice times in width of the film as the final product, but not restricted Preferably the device for regulating the temperature is with this casting die 50 in such that the casting is made with keeping the temperature predetermined. Further, preferably the casting die 50 is coathanger type, in which bolts (heat bolts) for automatically adjusting the thickness of the film are provided with predetermined slit interval in the width direction. Preferably the profile is set ahead corresponding to the flow volume by the pump 43 programmed by the heat bolts and the profile is also applicably set by feedback control with modulation based a the device for measurement of thickness not described in film product line 40 (for example, an infrared thickness measurement). In the film, except the both edge portions, the difference of the thickness at any two points apart was at most 1 μm, and further, preferably the difference of the minimal thickness in the width direction is at most 3 μm/m. And preferably the adjustment was made such that the accuracy of the interval of the lip might be under ±50 μm.

Preferably lip ends of the casting die 50 are provided with a hardened layer. In order to provide the hardened layer, especially not restricted to methods, there are methods of ceramic coating, hard chrome plating, nitriding treatment and the like. If the ceramics is used as the hardened layer, preferably the grind was possible, the porosity becomes lower, and was not friable and the good corrosion resistance. Further, as the preferable ceramics, there was no adhesive properties to the casting die. Concretely, as the ceramics, there are tungsten carbide that is WC, Al₂O₃, TiN, Cr₂O₃ and the like, and especially WC. Note in the present invention the hardened layer was formed by a tungsten carbidecoating in a spraying method.

Preferably the device for supplying the solvent is provided on the both edges of a die slit in order to prevent the discharged dope partially dried to be a solid. In this case preferably a mixture solvent to which the dope was dissoluble for example, a mixture solvent whose composition is dichloromethane 86.5 mass.pct, acetone 13 mass.pct, n-butanol 0.5 mass.pct) is supplied to both edges. The pump for supplying the dope has a pulsation at most 5%.

Below the casting die 50, there is the belt 53 supported by the rollers 51, 52. The belt 53 endlessly and circularly moves in accordance with a rotation of the rollers 51, 52 by a driving device (not shown). Preferably the moving speed of the belt 53, namely the casting speed is preferably in the range of 10 m/min to 200 m/min. Further, preferably a heat transfer medium circulator 54 is equipped with the rollers 51, 52 for keeping the temperature of the surface the belt 53 predetermined. Preferably, in each roller 51, 52, there is a passage in which the heat transfer medium with a predetermined temperature is fed, so as to keep the temperature of the rollers 51,52 to a predetermined value. Preferably temperature of the surface of the belt 53 is controlled to the predetermined value. Note that the surface temperature is preferably in the range of −20° C. to 40° C. In the embodiment of the present invention the temperature of the rollers 51,52 is kept predetermined.

And, the rollers 51, 52 are also usable as the support in itself. In this case, preferably roller moves with such a high accuracy that the deviation of the circulating velocity is at most 0.2%. In order for the rollers 51, 52 to move so accurately, preferably surface roughness of a contacting surface of the roller 51, 52 was at most 0.01 μm/m. The surface of the rollers 51, 52 are processed by the method of the hard chrom plating so that the rollers 51, 52 have the enough hardness and endurance. And Note that the support (the belt 53 and the roller 51, 52) preferably had no defect on surface. Concretely and preferably, the number of pinholes whose diameter was at least 30 μm was zero, that of the pinholes whose diameter was at least 10 μm and at most 30 μm was at most 1 per 1 m², and that of the pinholes whose diameter was less than 10 μm was at most 2 per 1 m².

The casting die 50, the belt 53 and the like are contained in a casting chamber 55 to which a temperature regulator 56 to keep the temperature predetermined and a first condenser 57 to recover a vaporized organic solvent by condensing is provided. And an recovering device 58 to recover the condensed organic solvent is provided to the outside of the casting chamber 55. And preferably a decompression chamber 60 is provided in the casting chamber 55 in order to control pressure at the backside of a casting bead formed from the casting die 50 to the belt 53.

Further, it is provided in the upper side of the belt 53 that an aeration duct 61 to vaporize a solvent in the casting film 59 with feeding air, an emission duct 62 to emit the vaporized solvent with the air, and the guide boards between the aeration duct 61 and the emission duct 62. These devices, which are the aeration duct 61, the emission duct 62 and the guide boards 64 are described in the other figure.

An air blower 71 is provided in an interval section 70, and a crasher 83 to crush into fragments (tips) the portions of the both edges of the film 81 to be cut away is provided in a edge slitting device 82 in the downstream of the tenter 80.

There are plural rollers 84 in the drying chamber 85, which has an recovering device 86 for adsorbing and recovering the solvent vapor. And, in FIG. 5, a cooling chamber 87 is provided in the downstream side from the drying chamber 85, but a moisture control chamber (not shown) may be provided between the drying chamber 85 and the cooling chamber 87. In the downstream side from the cooling chamber 87, a compulsory neutralization device (neutralization bar) 88 is provided such that the charged voltage of the film 81 may be in the range of −3 kV to +3 kV. In FIG. 5, the neutralization device 88 is disposed in a downstream side from the cooling chamber 87. However, the position of the neutralization device 88 is not restricted in this figure. Further, in an embodiment of this present invention a knurling roller 89 for providing a knurling with an embossing processing in the both edges of the film 81 is provided in the downstream side from the compulsory neutralization device 88. And, a winding roller 91 to wind the film 81 and a press roller 92 to control the tension at winding are provided inside the winding chamber 90.

An example of the method for producing a film by the film producing apparatus 40 like above will be described in the followings. The dope 36 is always uniformalized by being stirred with a stirrer 42. The additives (plasticizer, retardation controller, UV-absorbing agent and the like) can be mixed in a dope 36 in this stirring.

And, the dope 36 is transported by the pump 43 to the filtration device 44 in which the dope 36 is filtrated, and the dope 36 is cast from a casting die 50 to belt 53. Preferably a tension to the belt 53 is regulated to 1.5×10⁴ kg/m by the drive of two rollers 51,52. The difference of the relative speed of the rollers 51,52 and the belt 53 may be at most 0.01 m/min. Further, the fluctuation of the velocity of the belt 53 is at most 0.5%. The length of meandering in width direction generated in rotation at one time is at most 1.5 mm. Preferably the velocity of the rotation was regulated by feedback control based on the value from a detecting device (not shown) for detecting the positions of both edges, which is provided, in order to reduce this meandering. Further, preferably the positional fluctuation of the lips and the casting belt 53 just below the casting die 50, which is generated in rotation of the roller 51 in horizontal and vertical directions is regulated to at most 200 μm. And preferably the temperature in the casting chamber 55 is regulated in the range of −10° C. to 57° C. by the temperature regulator 56. Note that after solvent vaporized inside the chamber 55 is recovered by the apparatus 58, the reproduction is made for reusing recovered solvent as the solvent for preparing the dope.

A casting bead is formed from the casting die 50 to the belt 53, and a casting film 59 is formed on the belt 53. Preferably the temperature of the casting dope 36 is preferably from −10° C. to 57° C. Further, in order to stabilize the formation of the bead, preferably a decompression chamber 60 controls the pressure in a back side of the bead to predetermined value. Preferably the pressure in a back side of the bead is decompressed in the range of −10 Pa to −1500 Pa as the pressure of a front side of the bead is defined as 0 Pa. Further, preferably the temperature inside the chamber 60 is regulated with a jacket set on the decompressed chamber 60 so as to keep the predetermined temperature. Preferably an aspirator is provided at the edge portions of a casting die 50 to keep the form of a casting bead as desired. Preferably the volume of this aspiration is in the range of 1 L/min to 100 L/min.

After having a self-supporting property, the casting film 59 is peeled as a wet film 66 from the belt 53 with supported by a peeling roller 65. Thereafter, the wet film 66 is transported into the tenter 80 via the interval section 70 provided with plural rollers. In the interval section 70, a drying air with an predetermined temperature is fed from the air blower 71 such that the drying of the wet film 66 may proceed. The temperature of the drying air is preferably in the range of 20° C. to 250° C.

A wet film 66 is dried with transported with clips holding portions of the wet film 46 in the tenter 66. And the inside of the tenter 80 is preferably partitioned into plural partitions so as to regulate the drying condition with respect to each partition. Note that in the tenter 80 the wet film 66 can be stretched in the width direction. A wet film 66 is preferably stretched in the range of 100.5% to 300% at least one of directions of width or casting in at least one area whether an interval section 70 or the tenter 80.

The wet film 66, which is dried in the tenter 80 until containing a predetermined content of the remaining solvent, is transported into the downstream from the tenter 80 as the film 81. Both of the side edge potions of the film 81 are slit by the slitting device 82, and are transported to a crusher 83 with use of a cutter blower (not shown). The crusher 83 crushes the both edge portions into tips which are reused for preparation of the dope. This method is effective in view of the cost. Note that slitting process of the both edges of the film 81 can be omitted. However, it is preferable to slit both of the side edge portions them somewhere between the casting of the dope and the winding the film.

Meanwhile, in the embodiment of the present invention, the film 81 without portions of both side edges by cutting is transported into the drying chamber 85 and dried more. The temperature in the drying chamber 85 is not restricted especially, Drying the film 81 in the drying chamber 85 is made with the film 81 wrapped around the rollers 84. An recovering device 86 recovers and absorbs the solvent vapor which is vaporized. The air from which the solvent vapor is removed is fed as the drying air again. Note that the drying chamber 85 is more preferably partitioned into plural partitions so as to vary the drying temperature. Further, to provide a pre-drying chamber (not shown) between the edge slitting device 82 and the drying chamber 85 so as to make the pre-drying of the film 81, prevents the temperature of the film 81 from increasing rapidly. This is why deformation of the film 81 is reduced more.

The film 81 is cooled to about room temperature in a cooling chamber 87. Note that a moisture control chamber (not shown) may be provided between the drying chamber 85 and the cooling chamber 87. Preferably in this moisture control chamber, air in which moisture and temperature are controlled is fed toward the film 81. Thus winding defect of the film and the generation of curl are prevented when the film 81 is wound.

The various processes are made in a solution casting method in the period from the process the polymer film is peeled from the support to the process peeled film is wound. The various processes includes drying, cutting and removing the edges of the film. The film is transported and supported mainly by rollers in one process or between those each processes. The type of these rollers may be driving or non-driving type. The immovable roller is mainly used to determine a transporting path and to enhance a stability to transport.

While, a driving force is transmitted to the film from the driving rollers, thus the film is transported to the downstream direction. A suction roller is used as the driving roller. In transporting a film in the process of producing a film, the separation of the carrier tension is sometimes needed in the each process or between the processes, for example casting, peeling, drying, winding. In that case, the separation of the transporting tension is attempted to give the driving force to a film by the suction roller. This suction roller has a lot of holes on the surface to suck air. The sucking make drawing the film to the surface of the roller and the film is transported with rotating of the roller.

When the suction roller is used, compared with the non-driving roller, the film may be easily deformed because complicated force of which the directivity isn't specified affects the film. And, the film is also deformed by the difference of tension between before and after transporting. Further, plural holes aspirating the air are formed in the surface of the suction roller. If the film slip and the contraction and the deformation happen at the state that the film access on the edges of those holes, the film is damaged imperceptibly.

The surface of the driving roller used in the transporting process is hardened by the hardening process, that are chrome plating, nitriding treatment, quenching process and the like forehead. And, the hardness around surface is preferably in the range of 500 to 2000 as Vickers Hardness and more preferably, in the range of 800 to 1200 as Vickers Hardness.

Preferably a surface roughness Ry around the suction roller was in the range of 0.3 μm to 1.0 μm, and further, preferably in the range of 0.5 μm to of 0.8 μm. Preferably this surface roughness Ry is the roughness on the smooth area without holes. And, preferably the hole diameter is in the range of 1 [mm] to 6 [mm]. Further, more preferably in the range of 2 [mm] to 4 [mm]. The truncated chamfer width of that hole is in the range of 2% to 20% of the hole diameter.

When the the suction roller is used, the temperature around the surface is preferably regulated. Therefore, preferably at least one controller for controlling the temperature is provided to one suction roller. And, the temperature around the surface of the suction roller is higher than that of film at the time just before contacting each other.

It is preferable to provide a compulsory neutralization device (neutralization bar) 88 in such that the charged voltage of the film 81 may be in the range of −3 kV to +3 kV in transporting the film 81. The FIG. 5 shows that the neutralization device 88 is disposed in a downstream side from the cooling chamber 87. However, the position of the neutralization device 88 is not restricted in this figure. Further, it is preferable to provide a knurling roller 89 for making a knurling to the both edges of the film 81 with an embossing processing. Note that the asperity in the area in which the knurling is made is preferably in the range of 1 μm to 200 μm.

At last, the film 81 is wound around the winding roll 91 in a winding chamber 90. The winding is preferably made with an predetermined tension by a press roller 92. Note that it is preferable to change the tension from a start to an end of winding gradually. The length of the film 61 to be wound is preferably at least 100 m, and the width thereof is preferably at least 600 mm, and more preferably in the range of 1400 mm to 1800 mm. However, even if the width is over 1800 mm, the present invention is effective. Further, the present invention is applicapable to the case producing the thin film of which thickness is in the range of 15 μm to 100 μm.

The solution casting method of the present invention may be a co-casting method in which a co-casting of two or more sorts of the dopes are made such that the dopes may form a multi-layer film, or a sequentially casting method in which two or more sorts of the dopes are sequentially cast so as to form the multi-layer film. When the co-casting is performed, a feed block may be attached to the casting die, or a multi-manifold type casting die may be used. A thickness of each upper and lowermost layer of the multi-layer casting film on the support is preferably in the range of 0.5% to 30% to the total thickness of the multi-layer casting film. Furthermore, in the co-casting method, when the dope is cast onto the support, it is preferable that the lower viscosity dopes may entirely cover over the higher viscosity dope. Furthermore, in the co-casing method, when the dope is cast onto the support, it is preferable that the inner dope is covered with dopes whose alcohol contents are larger.

Note that Japanese Patent Application No. 2004-264464 teaches in detail the structure of the casting die, the decompression chamber and the support and the like, drying conditions in each processes (such as the peeling and the stretching), the co-casting method, a handling method, a winding method after the correction of planarity and curling, a recovering method of the solvent, a recovering method of film and the like the description of the above publication may be applied to the present invention.

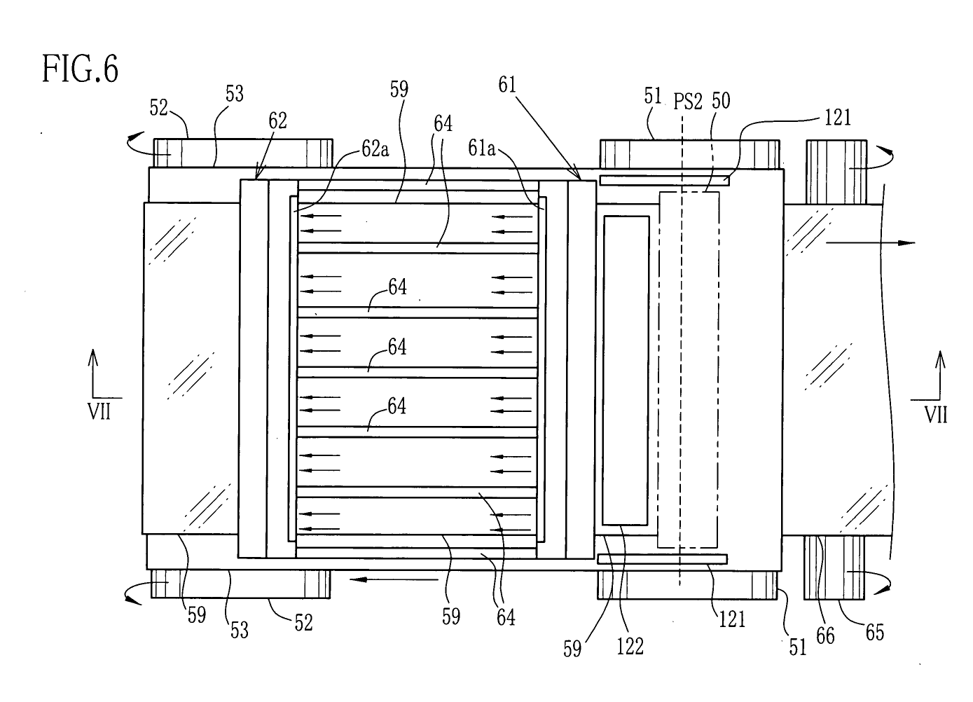

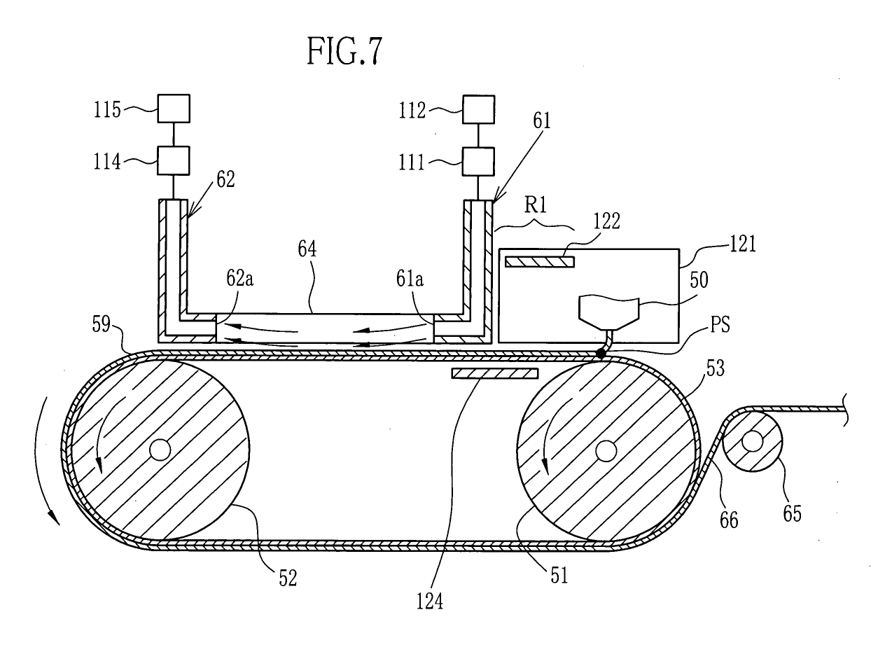

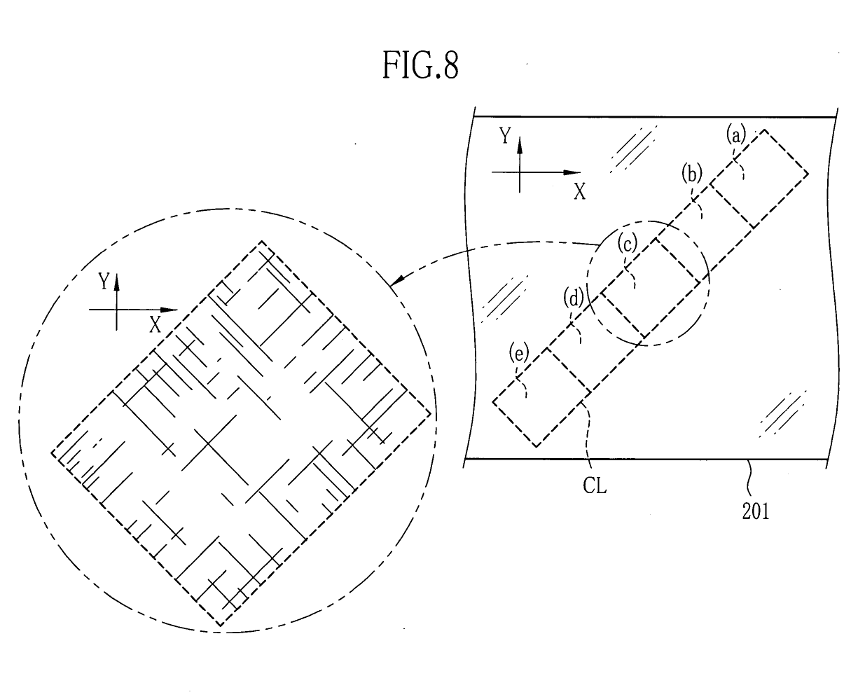

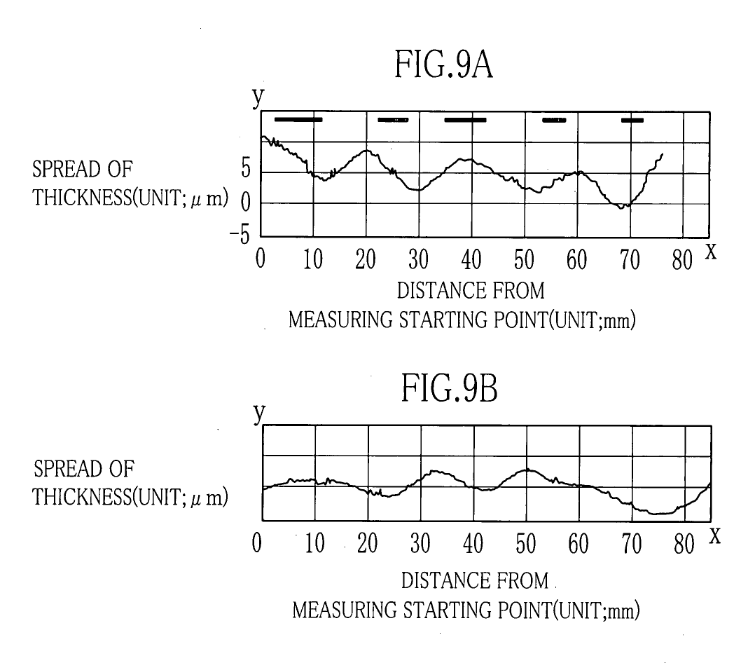

Then, A casting process is described in detail in followings referring to FIG. 6 and FIG. 7. But a drawing of a decompressed chamber on the upstream side of a casting die is omitted for avoiding that the drawing become complicated.

In the following explanation, portion of a downstream side from a casting starting line PS2 shown as a dashed line of FIG. 6 and a point in FIG. 7 direction to a downstream direction is defined as the casting film 59. An aeration duct 61 and an emission duct 62 are provided at the portion around the casting film 59 also and on the upper side of the casting film 59 aforementioned. And guide boards 64 are provided between the aeration duct 61 and the emission duct 62. Several guide boards 64 are disposed in the width direction. An exit 61a is provided at an aeration duct 61 along the width direction in such that the air is fed to the casting film 59 from the upstream side to the downstream side. And, An exit 62a is provided at the emission duct 62 along the width direction in such that the air is recovered and emitted effectively.

An air flowing controller 111 and an air blower 112 are provided with the aeration duct 61, and an emission controller 114 and the emission treatment unit 115 are provided with the emission duct 62. And, the temperature and the velocity of the air regulated by the emission controller 114, and the air is fed from the aeration duct 61 to the casting film 59. And, emitting force by the emission duct 62 is regulated by the emission controller 114. In the emission treatment unit 115, the solvent vapor from the emitted air is condensed and recovered, and the air without the solvent vapor is transported into the air blower 112.

In the embodiment of the present invention, the guide boards are provided adjacently between the exit 61a of the aeration duct 61 and the exit 62a of the emission duct 62 in such that an area between the exit 61a of the aeration duct 61 and the exit 62a of the emission duct 62 is partitioned into plural areas in the width direction. The guide boards may be disposed in contact to the exit 61a of the aeration duct 61 and the exit 62a of the emission duct 62. Thus, providing the guide boards 64 prevents some air flowing from the exit 61a in the width direction of the casting film and prevents some external air from side edges of the aeration duct 61 involved above the casting film 59. These can make reduced the generation of the thickness unevenness of the film in the oblique direction intersecting the longitudinal direction. Especially, among these guide boards 64, the ones at the both side edges prevent the air flowing in the width direction on both sides of the casting film 59 so that a phenomenon that the more near edges the casting film 59 is, the higher a level of thickness unevenness becomes is reduced effectively and the film 81 (reference with FIG. 1) without the optical unevenness can be produced as described above. And, the film is preferably used for a display device with high brightness and high definition, that is, the LCD with type of VA (Vertically Aligned) mode and OCB (Optionally Compensatory Bend) mode in which minute optical unevenness even becomes into trouble.

A position of the aeration duct 61 is determined not to be just back of the starting point PS2 but to be where the casting film 59 is solidified into predetermined hardness. This is how marks of the casting film with the air blowing and the like reduced.

And, more preferably, the area between the casting die 50 and the aeration duct 61 is made with no airflow in order to reduce the thickness unevenness of the film. In order to make this area with no airflow where is denoted as a notation R1 shown in FIG. 7, in the embodiment of the present invention, a wind shielding board 121 is provided. The windshielding boards (2) is disposed above the casting film 59 and prevents the airflow above the casting film 59. Further, providing a Labyrinth structure member along the moving direction of the casting film 59 can improve the ability to control that airflow. Namely, the Labyrinth structure improves the ability to control the flow of the air involved with the belt moving and reduces that volume. As substitute for this, the combination of the methods of drying the back side of the casting film and making the state with no airflow by a cooling condensation recovering method and the like improves the ability to control the air flow. Preferably this area R1 with no airflow is from the position where the casting film 59 is formed to the other position where the casting film 59 is dried to be approximately 150% of remaining solvent of the casting film 59. Note that the cooling condensation recovering method means the method that the solvent vaporized from a casting film is condensed by cooling with a second condensed board 122, which is provided above the casting film 59 as shown in FIG. 6 or FIG. 7. And, the method for drying a backside of the casting film 59 as described above and the like are mentioned that when the casting film is on a surface of the belt 53, a heater board 124 for heating is provided in the side of the opposite surface as shown in FIG. 7. This method, which means above providing a heater board 124 is operated in the embodiment of the present invention. Further, the co-casting method to form plural layers is made applied, and the dope concentration becomes less than that of the middle layer except the surface layer so that the thickness unevenness intermittently caused by accuracy of controlling the airflow and the like can be reduced. Thus, casting process can be operated faster.

[Characteristics, Measuring Method]

The application No. 2004-264464 teaches the characteristics and the measuring method of the cellulose acylate film, and may be applied to the present invention.

[Surface Treatment]

It is preferable to make a surface treatment of at least one surface of the cellulose acylate film. Preferably, the surface treatment is at least one of glow discharge treatment, plasma discharge treatment, UV radiation treatment, corona discharge treatment, flame treatment, and acid and alkali treatment.

[Functional Layer]

(antistatic agent, cured resin layer, antireflection layer, adhesive layer for easy adhesion, antiglare layer and an optical compensation layer)

A primary coating may be made over at least one surface of the cellulose acylate film.

Further, it is preferable to provide other functional layers for the cellulose acylate film as a film base so as to obtain a functional material. The functional layers may be at least one of antistatic agent, cured resin layer, antireflection layer, adhesive layer for easy adhesion, antiglare layer and an optical compensation layer. And Further, Conditions and methods of performing a surface treatment and providing a functional layer with several functions and characteristics are described in Japanese Patent Application No. 2004-264464. No. 2004-264464 can be applied to the present invention.

(Usage)

The cellulose acylate film can be used and utilized especially as the optical compensation which functioning as the protective film in a polarizing filter. To obtain a LCD, two polarizing filters, in each of which the cellulose acylate film is adhered, are disposed so as to overlay a liquid crystal layer. But the allocation at which the polarizing filter and the liquid crystal layer are positioned is not restricted but can be determined as the well-known allocation. The application No. 2004-264464 discloses TN type, STN type, VA type, OCB type, reflection type, and other example in detail. This method can be applied to the present invention. Further, the application teaches the cellulose acylate film provided with an optical anisotropic layer and that provided with antireflective and antiglare functions. Furthermore, the application supposes to provide the cellulose acylate film with adequate optical functions, and thus a biaxial cellulose acylate film is obtained and used as the optical compensation film, which can be used as the protective film for the polarizing filter simultaneously. The restriction thereof described in the application No. 2004-264464 can be applied to the present invention.

The obtained film can be used as a base film of a photosensitive material or a protective film in a polarizing filter, further a compensation film for improving the relativity to angle of eyesight for use of television. Especially the obtained film is effective as use of the compensation film and the protective film in the polarizing filter, therefore used not only for the ordinary TN type but also IPS type, OCB type and VA type. The polarizing filter may be comprised of the protective film for the polarizing filter.

And, in the present invention as described above, a film may be produced by a melting method instead of a solution casting method corresponding to the kinds of films. In this case, the melt-extrusion process is substitute for the casting process. The film is produced in such that after the polymer is melted with heated by some kind of die of melt-extrusion on sale and extruded as the form of a film, the extruded film is cooled. The extruded film may be stretched to a predetermined direction. Note that the method of cooling the extruded film may be a natural cooling or a cooling by a predetermined cooling device.

### EXAMPLE 1

Example of the present invention was explained. Note that the experiments was carried out with some condition of the producing process changed as shown in Table.1. The names of the experiments of each of conditions was defined as Experiments 1-14 and Experiments 15-17 as comparisons. Firstly, the composition of the polymer solution (the dope) used in the process producing the film is shown below.

[Composition]

| | | |
|---|---|---|
| cellulose triacetate(a degree of substitution 2.84, | 100 | mass. pct |
| viscosity-average degree of polymerization of 306, | | |
| moisture permeability 0.2 mass %, viscosity in | | |
| the dichloromethane solution 6 mass % 315 | | |
| mPa · s, powder, average of particle diameter | | |
| 1.5 mm and standard deviation 0.5 mm) | | |
| Dichloromethane (first solvent) | 320 | mass. pct |
| Methanol (second solvent) | 83 | mass. pct |
| 1-butanol (third solvent) | 3 | mass. pct |
| Plasticizer A (Triphenylphosphate) | 7.6 | mass. pct |
| Plasticizer B (Diphenylphosphate) | 3.8 | mass. pct |
| UV-absorbing agent a: | 0.7 | mass. pct |
| 2-(2′-hydroxy-3′,5′-di-tert-butylphenyl)benzotriazol | | |
| UV-absorbing agent b: | 0.3 | mass. pct |
| 2-(2′-hydroxy-3′,5′-di-tert-amylphenyl)- | | |
| 5-chlorobenzotriazole | | |
| citric acid ester mixture(citric acid, citric acid | 0.006 | mass. pct |
| monoethylester, citric acid dietylester, citric acid | | |
| trietylester) | | |
| particles(silicon dioxide(diameter 15 nm, Mohs | 0.05 | mass. pct |
| hardness approximate 7) | | |

Further, in order to control an optical property, compound as shown in chemical formula 57 was added with the volume changing. Note that each adding volumes of chemical formula 57 were shown in rate of additive in table 1. This adding coefficient was the weight ratio for the cellulose triacetate

chemical 57

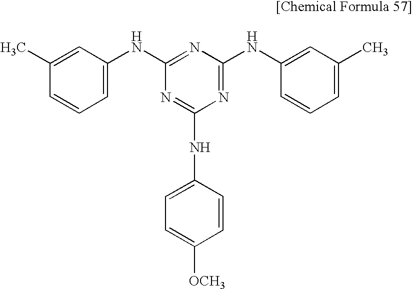

[Cellulose Triacetate]

Note that cellulose triacetate was used in which content of remaining acetic acid is less than 0.1 wt. %, and content of Ca is 58 ppm, content of Mg is 42 ppm, content of Fe was 0.5 ppm, content of Fe was 0.5 ppm, content of releasing acetic acid is 40 ppm, further content of ion sulfate is 15 ppm. Degree of acetyl at 6^{th} position is 0.91 and that content is 32.5% of all acetyl and content of TAC extracted by the acetone is 8 wt. %. A ratio of the average of molecular weight by weight to the average of molecular weight by number is 2.5. And yellow index of the obtained TAC is 1.7, haze is 0.08 and transparency is 93.5%. Tg(glass transition point measured by DSC) was 160° C. and calorific value in crystallization is 6.4 J/g. This was called cotton material TAC in below description.

(1-1) Dope Preparation

A Dope 36 was prepared by the dope producing apparatus 10 for producing a dope in FIG. 5. The the dope producing apparatus 10 has the stainless dissolving tank 13 with volume 4000 L which had the stirring blade. The plural of solvent mixed and stirred so fully that the plural solvent grew into an admixture solvent. Note that those solvent were used of which moisture content in each was preferably at most 0.5 mass. %. Powder of the TAC as form of flake was gradually took into the dissolving tank 13 from the portion of hopper. Powder of the TAC was dispesed in the dissolving tank 13 for thirty minutes. The dispertion was made by a stirring device with decentering stirrer of dissolver type. Temperature at a start of dispertion was 25° C., and that at the end of dispertion was 48° C. Further, an ahead prepared additive solution was transported into the dissolving tank 13 with volume regulated by a valve. The all amount of the weight of the dissolving tank including the additive solution was 2000 kg. The dispertion of the additive solution ended and fast-moving stirring stopped, thereafter further, the additive solution was stirred for 100 minutes with the rotation velocity of anchor blade predetermined value and swollen. Then the swollen solution is obtained. Inside of the tank has been pressurized to 0.12 MPa until the swelling finished. At this time the state in the inside of the dissolving tank was kept without difficulty in terms of prevention of explosion with the oxygen concentration less than 2 vol %. And the content of the water was 0.3 mass. % in the swollen solution.

(1-2) Dissolution and Filtration

The swollen solution was transported by a pump from the dissolving tank 13 to a pipe with jacket. The swollen solution is heated to 50° C. at the pipe with jacket, and further, heated to 90° C. under the pressure of 2 MPa, so the swollen solution is dissolved completely. At this time, the heating time was 15 minutes. Next, the dissolved solution fell to a temperature of 36° C. and was filtrated by the filtration device with filter whose nominal pore diameter is 8 μm. The dope was obtained (called the primary dope in followings). At this time pressure at the primary side was 1.5 MPa and pressure at the second side was 1.2 MPa in the filtration apparatus. About the filter, housing and pipe, which reaches to high temperature, the material is XASTELLOY alloy and excellent in anti-corrosion and has the jacket in which the heat transfer medium for heat transfer passes through.

(1-3) Condensed, Filtration, Removal of Foam, Additives

The primary dope obtained in this way was flushed with a flashing device 31 under atmospheric pressure and at the temperature of 80° C., and the vaporized solvent was condensed and recovered by a condenser. This is how the concentration of the dope is regulated as Table 1 shown. Note that the condensed solvent was transported to the solvent tank 11 after recovered for reuse in the recovering device 32 and reproduced in the reproducing device 33. Distillation, dehydration and the like was made in the recovering device 32 and the reproducing device 33. The stirrer which has the anchor blade on the stirring shaft was provided inside the flashing tank such that the foam in the flashed dope was removed by stirring. The dope in the flash tank is at the temperature of 25° C., and the residual time of the dope in the tank was 50 minutes. The viscosity shear measured at the temperature of 25° C. was 450 Pa.s at shear velocity of 10 (sec⁻¹).

Then, this dope is exposed to ultrasonic in such that the removal of the foam was made. Next, this dope passed through the filtration device at the pressure of 1.5 MPa by pump. In the filtration device, this dope firstly passed through a metal sintered filter whose nominal pore diameter is 10 μm and secondly passed through a sinistered filter whose nominal pore diameter is 10 μm. The primary side pressures at each filtration were 1.5 MPa and 1.2 MPa, and the secondary pressures at each filtration were 1.0 MPa and 0.8 MPa. After the filtration, the temperature of the dope was regulated to be 36° C. and, transported and stored into a stainless stock tank with volume of 2000 L. The stock tank comprised a stirrer which had the anchor blade on the central rotating shaft. Thus content of the stock tank is stirred continuously. Further, a problem, that is corrosion and the like, never happened in the devices where the dope, the primary dope and solvent and the like contact.

And, a mixture solvent A was made of dichloromethane (85.5 mass.pct), Acetone (13 mass.pct) and butanol (13 mass.pct).

(1-4) Discharge, Additives just now, Casting, Bead Depression

The film 81 was produced in an film producing apparatus 10 as shown in FIG. 5. The dope 36 in a stocktank 30 was transported into a filtration device 44 by a high-precision gear pump 43. This pump 43 has the function to boost the pressure in the primary side. The pressure in the primary side is controlled to be 0.8 MPa by feedback for the upstream side of the pump 15. The volume efficiency of the pump 15 is 99.2%. And the fluctuation of the volume of discharge is at most 0.5%. The pressure of discharge was 1.5 MPa. And, the dope 36 having passed through the filtration apparatus was transported to a casting die 50.

Casting was made in such that the flow volume of the dope 36 at the exit of die 50 was regulated so as to make the thickness of the film 81 80 μm. A width of a casting die 50 was 1.8 μm. And the width of the dope casting from the exit of die 50 was 1700 mm. In order to regulate the temperature of the dope 36, a jacket (not shown) was provided with the casting die and the temperature of the heat transfer medium 50 supplied to the olifice of the jacket (not shown) was 36° C.

Temperature of a casting die 50 and pipelines was controlled to 36° C. in operating. And the casting die 50 was coathanger type, in which bolts for adjusting the thickness of the film were provided. Each pitch of bolts is 20 mm. which had the mechanism to regulate the thickness automatically by heat bolt. The film 81 except the both edges of one whose width is 20 mm had the property that the difference of the thickness was at most 20 mm between two optional points having the pitch of 50 mm, the thickness unevenness in width direction was at most 3 μm/m, and difference both between average and a maximum and average and a maximum in the thickness in all area of the film 81 was regulated at most 1.5% of the average thickness.

And, a decompression chamber 60 was provided in the primary side of the casting die 50 in order to decompress this area. The degree of the decompression of this chamber 60 was regulated such that the difference of the pressure between at downstream side and at upstream side from the casting die 60 is made to be in the range of 1 Pa to 5000 Pa. The regulation of this decompression was in accordance with a casting speed. The difference of the pressure at downstream side and at upstream side from the casting die 60 was set such that the length of the bead is made predetermined value. And, the decompress chamber has the mechanism to set higher temperature than that of condensation of gas around the casting position. The Labyrinth packing(not shown in figure) is provided in the front and the back side of the bead in the exit of discharging the die. And, the portion of the exit is provided at the both edges of the die. Further, aspirator is provided with the die 50 to regulate the change of the bead foam to be const.

(1-5) Casting Die

The material of the casting die 50 was a precipitation hardened stainless or a stainless having double-phase structure. The material had coefficient of thermal expansion of at most 2×10⁻⁵(° C.⁻¹), the almost same anti-corrosion properties as SUS316 in examination of corrosion in electrolyte solution. Further, when the material was dipped in a mixture liquid of dichloromethane, methanol and water, pitting (holes) were not formed on the gas-liquid interface. In this embodiment, the slit clearance was 1.5 mm.

Further on the exit of a casting die 50, in order to prevent the solidification of the dope 36, a mixture solvent to which the dope 36 was dissoluble was supplied at 0.5 ml/min to beads edges and the air-liquid interface of the slit. The pump for supplying the dope has a pulsation at most 5%. Further, the pressure at the rear side (or the upstream side) of the bead was lower than that of the front side by 150 Pa. Further, in order to make the temperature in the decompression chamber 40 constant, a jacket (not shown) was provided. Into the jacket, a heat transfer medium whose temperature was regulated to 35° C. was fed. The airflow of the edge suctioning was in the range of 1 L/min to 100 L/min, and in this embodiment, the airflow rate was regulated in the range of 30 L/min to 40 L/min.

(1-6) Material Support

The belt 53 was a stainless endless belt that was 2.1 m in width and 70 m in length. The thickness of the belt 53 was 1.5 mm and the polishment was made such that a surface roughness was at most 0.05 μm. The material was SUS 316 and had enough corrosion resistance and strength. The thickness unevenness of the belt 53 was at most 0.5%. The belt 53 was rotated by drive of two rollers 51,52. At this time, a tension to the belt 53 was regulated to 1.5×10⁵ N/m², and the difference of the relative speed of the rollers 51,52 and the belt 53 was at most 0.01 m/min. Further, the velocity fluctuation of the belt 53 was at most 0.5%. The rotation was regulated with detecting the positions of both edges such that the film meandering in width direction for one rotation might be regulated to at most 1.5 mm. Further, the positional fluctuation in horizontal directions of the lips and the casting belt just below the casting die 50 was at most 200 μm. And, the belt 53 is provided in the casting chamber (not shown in figure) with the device whose function is to control the fluctuation of the airflow pressure.

In order to regulate the temperature of the belt 53, the backup rollers 51,52 were used so as to be able to transport the heat transfer medium into the inside of them. Into the roller 51 in a side of the casting die 50 was fed the heat transfer medium (water) at 5° C. and into the roller 52 was fed the heat transfer medium (water) at 40° C. for drying. The surface temperature of the middle portion of the belt 53 just before the casting was 15° C., and the temperature difference between both side edges was at most 6° C. Note that the belt 53 preferably had no defect on surface, and especially preferably, the number of pin holes whose diameter was at least 30 μm was zero, that of the pinholes whose diameter was from 10 μm to 30 μm was 1 per 1 m², and that of the pinholes whose diameter was less than 10 μm was 2.

Drying Casting

The temperature of the casting chamber 55 was kept to 35° C. by a temperature regulator 56. The dope 36 is cast onto the belt 53 to form the casting film 59, to which the airflow to the casting film 59 was fed from the aeration duct 61. Note that the airflow was made emitted from the emitting duct 62 and was controlled by the guide board 64. The airflow volume VS (m³/min) from the emitting duct 61 and the temperature of the airflow TS(° C.) was made changed as shown in the table1. And, the air was fed to the portion below the belt 53 by a blower(not shown in figure) so as to keep 65° C. in temperature. The saturation temperatures in each drying air were both approximate −8° C. The oxygen concentration in the dry atmosphere was held at 5 volume %. Note that the displacement of air to Nitrogen gas is made so as to keep this oxygen concentration at 5 volume %. And in order to recover the solvent in the casting chamber by condensing, the condenser was provided and the temperature at the exit of the casting chamber was set to −10° C.

Note that a wind shielding board (not shown in figure) was provided with such that the airflowing didn't directly apply to the dope 36 and the casting film 59 for five seconds from the PS2, and the fluctuation of the static pressure was reduced at most ±1 Pa. When the ratio of solvent in the solution casting film 59 reached to 50 mass. % at Dry-Base, the solution casting film 59 was peeled as the film 81 from the casting belt 53 supported by a peeling roller 65. Note that the content of the solvent at this Dry-Base was calculated on the following formula. formula:
Content of Solvent={(x−y)/y}×100
W1: weight(gw) of a film in sampling
W2: weight(gs) of the film sample after the drying
   Further, at this time, the tension of peeling was 1×10² N/m² and the ratio of the velocity of peeling to that of belt 53 was moderately regulated in the range of 100.1% to 110%. The temperature of surface of the peeled film was 15° C. The average of velocity of the drying on the casting belt 53 was 60 mass. %/min. Note that this valve is based on the content of solvent at Dry-Base. The solvent gas generated in drying is condensed and liquefied by the condenser at temperature of −10° C. and recovered by the apparatus for recovering. The water content in the recovered solvent was regulated to at most 0.5% to reuse the solvent. The drying air in which the solvent removed was heated again and reused as the drying air. The film 81 was transported into a tenter dryer 80. In this transporting, the drying air (40° C.) was fed to the film 81 by an air blower. Note that the tension of the predetermined value was applied in transporting by rollers in the interval section.

Transporting in Tenter, Drying, Slitting

The film 81 was transported in the drying zone in the tenter 80, then the both side edge portions of the film 81 were held by clips. In this time, the film 81 was dried by air. The clips were cooled by supplied with a heat transfer media at the temperature of 20° C. The clips were transported by chain in the tenter 80, and the fluctuation of velocity of that sprocket was at most 0.5%. The gaseous composition of the drying air was the same as that in the saturation gas at the temperature of −10° C. The average of drying velocity was 120 mass. % (at Dry-Base solvent)/min in the tenter 80. The condition in the drying zone was regulated so as to make the content of the remaining solvent at the exit of the tenter 80 7 mass. %. The film 81 was transported in tenter 80 with being stretched in the width direction. Note that when the width of the film 81 before stretching was 100%, this stretching was made such that the width of the film after stretching reached to 103%. The stretching ratio of the peeling roller the entrance of the tenter 80 was 102%. And, the ratio of the length from the entrance to the exit of the tenter 80 to the length from the position at which the clips started holding to the position at which the clips ended holding was 90%. The solvent vaporized in tenter 80 was condensed, liquefied at the temperature of −10° C. and recovered. The condenser is provided for condensation and recovering. The temperature of the exit was set up to −8° C. And the water content in the condensed solvent was regulated at most 0.5 wt. % and reused.

The side edge portions of the film 81 were slit off from the exit of the tenter 80 by the edge slitting device 81 in thirty minutes.

(1-9) After Drying/Neutralization

The film 81 was dried at the high temperature in the drying chamber 85. The drying air was fed to the the drying chamber 85, which is partitioned into four partitions, in each of which the air at 120, 130, 130 and 130° C. in this order from the upstream side was fed from the air blower (not shown). The tension by the roller 84 in transporting the film 81 was regulated as predetermined and the film 81 was dried for ten minutes such that the content of the remaining solvent of the film 81 finally reached to 0.3 mass. %. The wrapping angle which is the central angle in winding films in the the roller 84 was 90° or 180°. The material of the roller 84 was aluminum or carbon steel, and a hard chrome coating was made on a surface or periphery. Two types of the rollers 84 were used. In the first type, the surface of the roller 84 was smooth, and in the second type, the blasting was made by the matting process on the surface. The positional fluctuation (or eccentricity) of the film 81 on the roller 84 was at most 50 μm, and the bending of the roller 84 under the predetermined tension was 0.5 mm.

The solvent vapor in the drying air was removed by the adsorbing device(not shown in figure). The adsorptive agent was activated carbon, and the desorption was mad with the dried nitrogen. The water content of the recovered solvent was made at most 0.3 mass. %, and thereafter the recovered solvent was used for the solvent for preparing the dope. The drying air includes not only the solvent vapor but also other compounds such as plasticizer, UV-absorbing agent and compounds of high boiling points. Therefore the other compounds are removed with cooling by cooling device and a preadsorber, and recycled. Then the adsorption and desorption conditions were set such that VOC (volatile organic compounds) in the exhaust gas might become at most 10 ppm. And, in all vapor solvent, the content of the solvent recovered by the condensing method was approximate 90 mass. %, and the content of remaining was mainly recovered by the adsorption.

The dried film 81 was transported into a first moisture control chamber(not shown). The drying air at 110° C. was fed into an interval section between the drying chamber and the first moisture control chamber. The air with the temperature of 50° C. and the dew point of 20° C. was fed in the first moisture control chamber. Further, in order to reduce the generation of the curling, the film 81 was transported into a second moisture control chamber (not shown). The air with the temperature 90° C. and the humidity of 70% was directly fed to the film 81 in the second moisture control chamber.

(1-10) Knurling, Winding Condition

The film 81 after moisture controlling was cooled to less than 30° C., of which both edge portions were slit off or trimmed by the second edge slitting device. A compulsory neutralization device (neutralization bar) 88 was provided in such that the charged voltage of the film 81 in transporting may be in the range of −3 kV to +3 kV in transporting the film 81. Further, then knurling of the both sides of the film 81 was made by a knurling roller 89. The knurling was performed by embossing process from a side. The pressure of the knurling was regulated in such that average width of the area for knurling might be 10 mm, and the maximal height might be 12 μm larger than the averaged thickness of the film 81.

Thereafter, the film 81 was transported into the winding chamber 90 in which the temperature and the humidity were kept to 28° C. and 70%. Further, an ionizer (not shown) was disposed in the winding chamber 90 in such that the charged voltage might be in the range of −1.5 kV to +1.5 kV. Thus the film 81 was obtained to have the width of 1475 mm. The diameter of the winding shaft in the winding chamber 90 was 169 mm. The tensions in the beginning of winding and in the end of winding were regulated to the predetermined. The total length of the wound-up film was 3940 m. One cycle which is the length on weaving was 400 m, and the fluctuation range in the width direction in winding (sometimes called the oscillation range) was from −5 mm to +5 mm. And, the pressure by the press roller 92 for the winding shaft was set up to the predetermined value. In the winding, the temperature of the film 81 was 25° C., and the water content was 1.4 mass, %, the content of the remaining solvent was less than 0.3 mass. %. The average drying velocity in all process was 20 mass. % (drying standard)/min. And, the winding absorption, cockle didn't generate, and the winding deviation didn't also in the impact test under 10 G. And, the appearance of the film roll is in a good condition. Note that the thickness average(unit: μm) of the obtained film is shown in Table 1.

The film roll was stored in the storing rack with the temperature of 25° C. and the relative humidity of 55% (hereafter shown as 55% RH) for one month. Then, at the result of the examination as above, the change wasn't recognized. Further, the adhesion of the film wasn't recognized in the inside of the film roll. After producing the film 81, the remaining of the peeled casting film on the casting belt 53 was not recognized all.

(1-11) Evaluation and Result

The films, which obtained in the above experiment from 1 to 14 and the experiments 15-17 as comparisons, is evaluated in terms of the retardation in aspect Re, the deviation V and the optical unevenness. The results of those evaluation are shown in table 1. Note that the deviation is calculated on the thickness data measured along the direction of the angle of 45° to longitudial direction. The visual test for the optical unevenness is made. In this test, the obtained film is affixed on the surface of glass board, and the board is disposed between polarizing filters whose state is at crossed nicols, and then is lightened from the backside. ⊚ means the optical unevenness is not observed at all. ◯ means the optical unevenness is observed inappreciably but has no influences on practical use. Δ means the optical unevenness is observed slightly but has no influences on practical use. × means the optical unevenness is observed distinctly.

TABLE1

| | | | | | Maximum |
|---|---|---|---|---|---|
| | Concentration | Rate of | | | Stretch |
| Experiment | of dope | Additive | VS | TX | Ratio |
| Experiment 1 | 19.8 | 4.2 | 150 | 100 | 24.8 |
| Experiment 2 | 19.8 | 5.1 | 130 | 100 | 24.8 |
| Experiment 3 | 19.8 | 5.1 | 170 | 120 | 24.8 |
| Experiment 4 | 19.8 | 4.2 | 150 | 140 | 32.0 |
| Experiment 5 | 19.3 | 4.4 | 130 | 100 | 24.8 |
| Experiment 6 | 19.3 | 5.1 | 130 | 100 | 24.8 |
| Experiment 7 | 19.3 | 3.9 | 130 | 100 | 24.8 |
| Experiment 8 | 19.3 | 2.9 | 170 | 140 | 32.0 |
| Experiment 9 | 19.0 | 4.8 | 150 | 100 | 24.8 |
| Experiment 10 | 19.0 | 2.9 | 130 | 120 | 32.0 |
| Experiment 11 | 19.0 | 5.4 | 130 | 100 | 24.8 |
| Experiment 12 | 19.0 | 2.9 | 130 | 120 | 32.0 |
| Experiment 13 | 19.0 | 5.1 | 170 | 140 | 24.8 |
| Experiment 14 | 19.0 | 3.1 | 130 | 140 | 32.0 |
| Experiment 15 | 20.2 | 4.4 | 150 | 120 | 24.8 |
| Experiment 16 | 20.2 | 5.4 | 130 | 100 | 24.8 |
| Experiment 17 | 19.8 | 5.1 | 150 | 140 | 32.0 |

| | Removing | Thickness | | V | Optical |
|---|---|---|---|---|---|
| Experiment | Stretch Ratio | average | Re | (×10⁻⁵) | unevenness |
| Experiment 1 | 19.4 | 92 | 33.4 | 115 | Δ |
| Experiment 2 | 19.4 | 88 | 37.6 | 82 | ◯ |
| Experiment 3 | 19.4 | 94 | 37.6 | 183 | Δ |
| Experiment 4 | 25.4 | 92 | 42.0 | 102 | Δ |
| Experiment 5 | 19.4 | 92 | 34.3 | 75 | ◯ |
| Experiment 6 | 19.4 | 88 | 37.6 | 51 | ◯ |
| Experiment 7 | 19.4 | 94 | 31.9 | 119 | Δ |
| Experiment 8 | 25.4 | 92 | 32.3 | 60 | ◯ |
| Experiment 9 | 19.4 | 88 | 36.2 | 15 | ⊚ |
| Experiment 10 | 25.4 | 88 | 32.4 | 10 | ⊚ |
| Experiment 11 | 19.4 | 92 | 38.9 | 32 | ◯ |
| Experiment 12 | 25.4 | 92 | 32.6 | 20 | ⊚ |
| Experiment 13 | 19.4 | 94 | 37.5 | 38 | ◯ |
| Experiment 14 | 25.4 | 94 | 34.0 | 25 | ⊚ |
| Experiment 15 | 19.4 | 90 | 35.0 | 324 | X |
| Experiment 16 | 19.4 | 92 | 42.3 | 388 | X |
| Experiment 17 | 25.4 | 96 | 13.3 | 312 | X |

From those above experiments as an example of the present invention, the optical unevenness is observed in the area in which the fluctuation of thickness and the deviation of the rate of change of thickness at the measuring point are large. Thus, the present invention can make the generation of the optical unevenness of the film reduced effectively, so that applying this film to a LCD with big screen and high brightness make the generation of displaying unevenness in the width and endways directions reduced effectively.

1. A polymer film produced to be long by a solution casting method or a melt-extrusion method comprising a following characteristic:
difference both between average and a maximum and between average and a minimum in thickness of said polymer film measured in a direction (except 90°) intersecting the longitudinal direction being at most 2 μm.

2. A polymer film produced to be long by a solution casting method or a melt-extrusion method comprising a characteristic which satisfies a following formula:
V<300×10⁻⁵
;wherein
V=Σ{(dYₙ)/(dXₙ)}²/n,
(dYₙ)/(dXₙ): rate of change of Yₙ with respect to Xₙ,
n: number N of measuring values arbitrarily selected from a thickness data along a direction (except 90°) intersecting the longitudinal direction (n is natural number and at least 5.),
Xₙ (unit;mm): distance between a starting point PS1 of the measuring and each measuring point Pₙ corresponding to each of said selected measuring value,
Yₙ (unit; μm): thickness on each of said measuring point Pn.

3. A polymer film as claimed in claim 1, wherein said polymer film is used as a protective film in a polarizing filter which has said protective film on a polarized film; and said polarizing filter being in a liquid crystal display which has an illuminator having brightness at least 8000 candela and also at most 50000 candela.

4. An apparatus for a solution casting method comprising:
a casting device for casting a polymer solution from a casting die onto a moving support to form a casting film and peeling said casting film, so as to form a film containing a solvent;
a drying device for drying said film;
an aerating unit provided near said support for applying air to said casting film;
a recovering unit provided near said support for recovering said air containing said solvent vaporized from said casting film at downstream side from said aerating unit ; and
plural guide members provided between said aerating unit and said recovering unit, wherein said plural guide members make a flowing direction of said air to be along a direction in which said casting film moves.

5. A solution casting method comprising steps of:
casting a polymer solution on a moving support to form a casting film;
peeling said casting film so as to form a film containing a solvent;
feeding air by an aerating unit to said casting film which is solidified into a certain hardness;
making a flowing direction of said air to be along a direction in which said casting film moves, wherein a direction of said air is controlled by guide members; and
recovering said air containing said solvent vaporized from said casting film by a recovering unit.

6. A solution casting method described in claim 5, maintaining a windless state around said casting film until said casting film becomes to be a predetermined hardness.

7. A solution casting method described in claim 6, wherein said solvent vaporized from said casting film is condensed by a condenser so as to accelerate drying of said casting film.

8. A solution casting method described in claim 6, heating with using a heater on an opposite surface of said support to a casting surface onto which said polymer solution is cast.
